(19) United States
(12) Patent Application Publication
(10) Pub. No.: US 2026/0225687 A1
(43) Pub. Date: Aug. 6, 2026

(54) The performance of dual flow conversion buoyancy to the ships process that reduce resistance

(71) Applicants: Xiangyu Hu, Huangshi, Hubei (CN); Kan Hu, Huangshi, Hubei (CN)

(72) Inventors: Xiangyu Hu, Huangshi, Hubei (CN); Kan Hu, Huangshi, Hubei (CN)

(21) Appl. No.: 19/139,333

(22) PCT Filed: Apr. 8, 2025
(86) PCT No.: PCT/CN2025/087695

§ 371 Date: Jun. 14, 2025

(30) Foreign Application Priority Data
Mar. 7, 2024 (CN) 202410317148.1

(51) Int. Cl. B63B 1/40; B63B 3/40; B63B 71/00

(52) U.S. Cl. CPC B63B 1/40; B63B 3/40; B63B 71/00

(57) ABSTRACT

One new type ship, forecast of dual flows conversion force, gravity and buoyancy distribution, the application and the methods of process the reduce resistance technology to the ships; the forecast of cache vector value affect the navigational speed of the ships; flat structure ship body utilize the air flow, mutual conversion of water flow and isolate the rub resistance and sticky pressure resistance of the wet superficial area water to the ship body which ≥80%; make the min draft depth achieve the max reduce resistance value relatively, reduce the cache vector value; use the same power of 25%~35% of the energy to supply the axial flow air compressor or the compressor working combine with propeller power, able to improve the navigation speed which ≥70% under the premise that same draft volume and same power; able to make the super big type ships able to navigating by water under navigation speed 25~65 Kn; increase 50%~100% of the deck area; able to resist the strike of the typhoon which above level 17 and the high seas; able to save on water ships energy consumption which ≥65% when navigating at 15~25 Kn; flat structure ship body has better course stability, better gyration; suitable to applications of sea, river and lake ships.

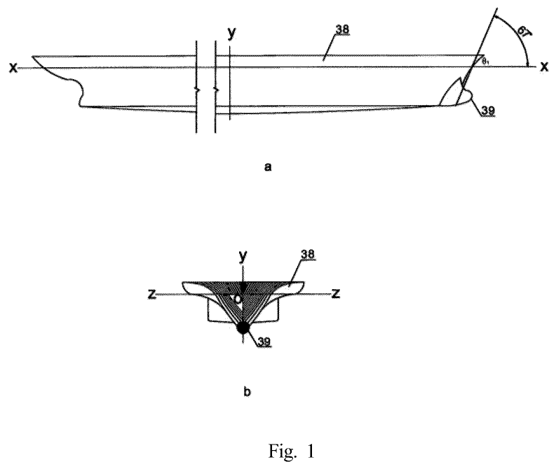

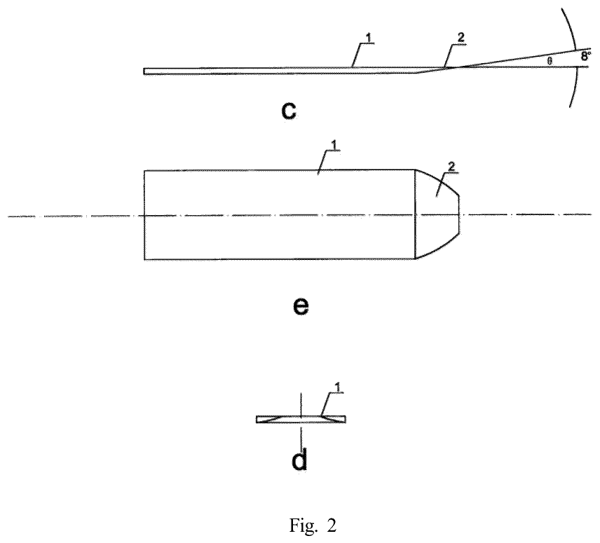

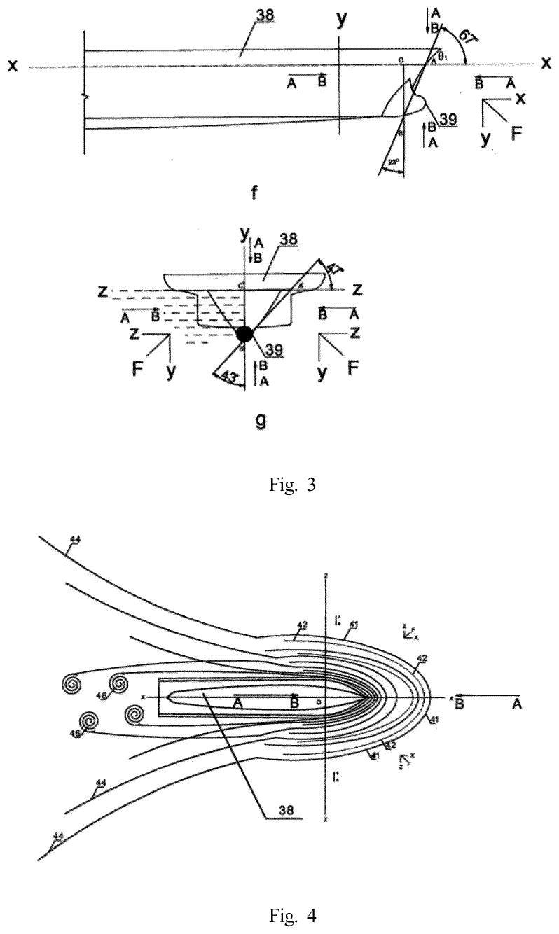

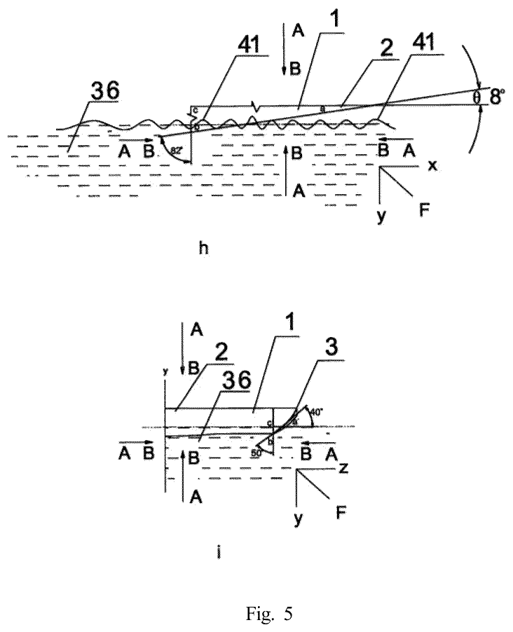

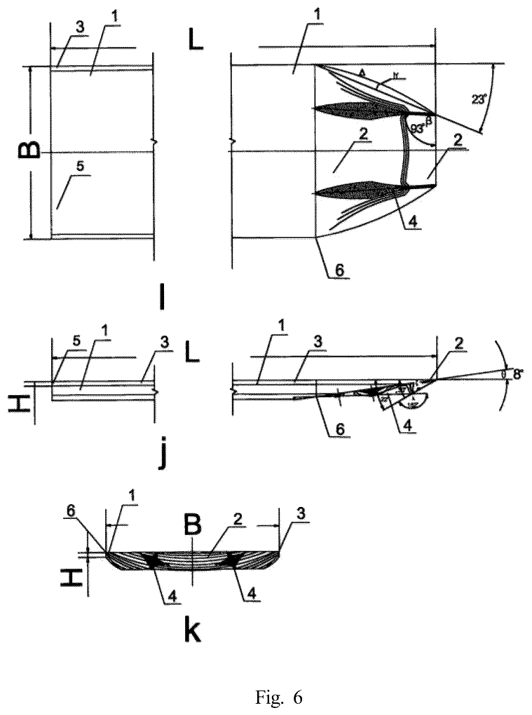

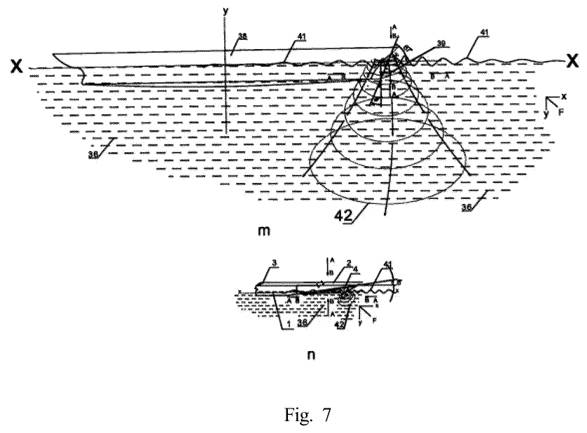

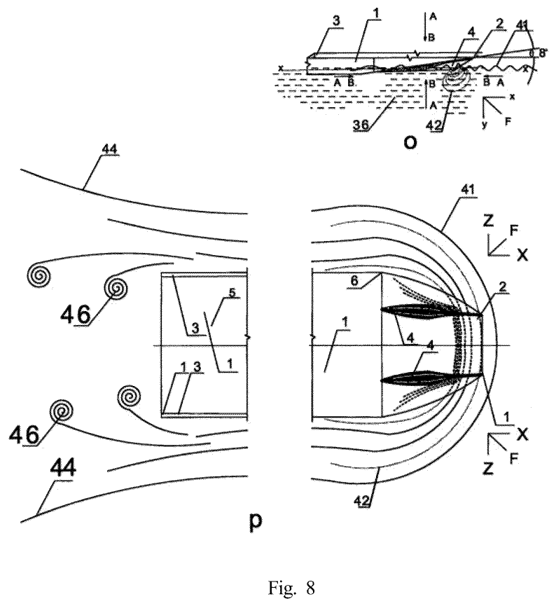

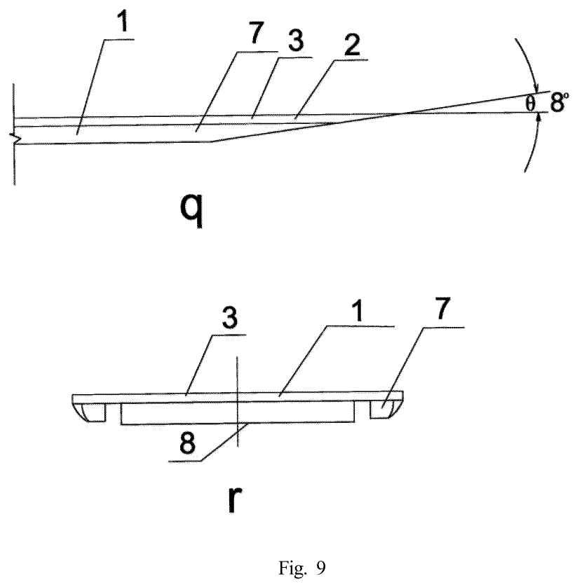

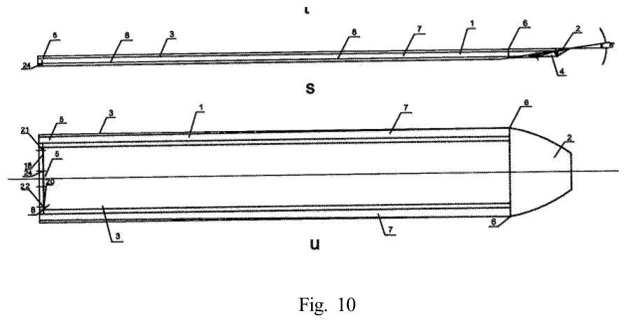

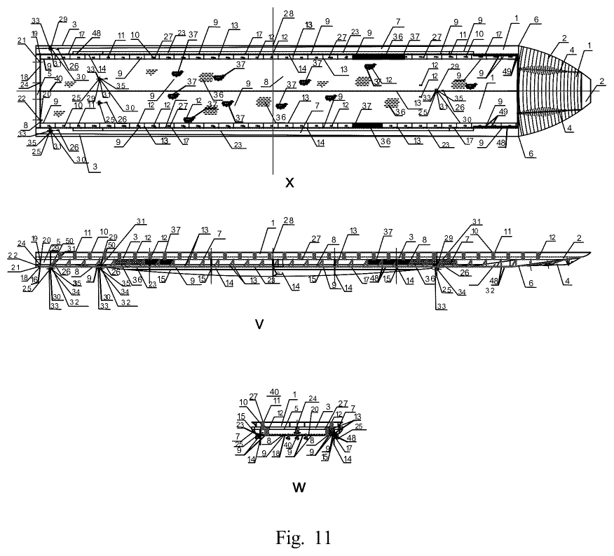

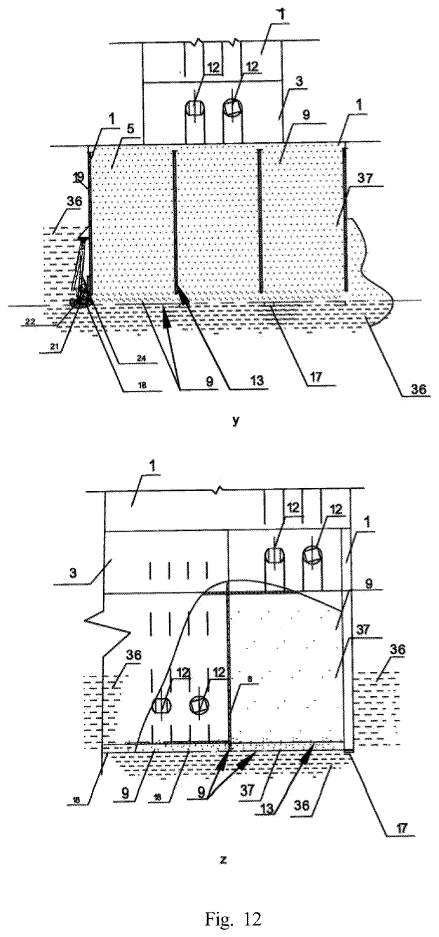

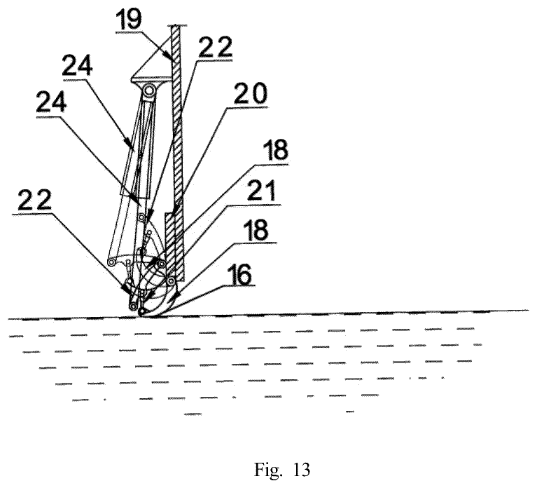

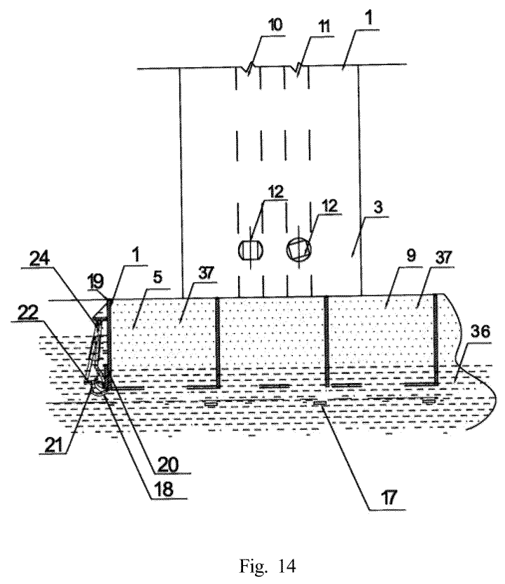

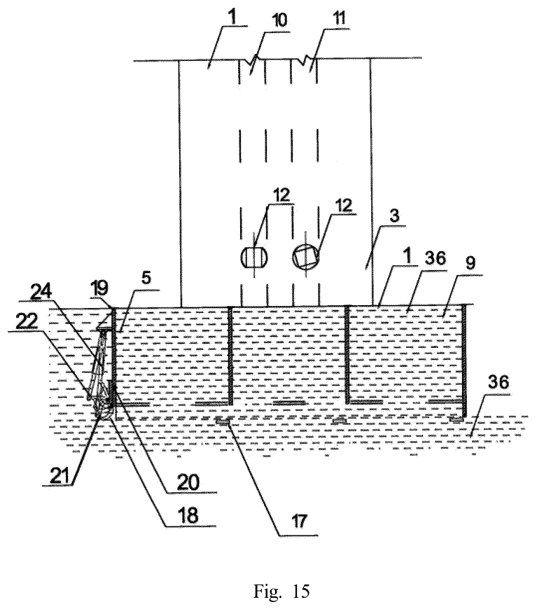

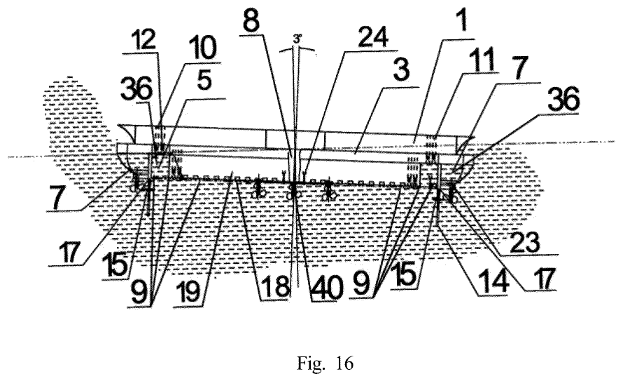

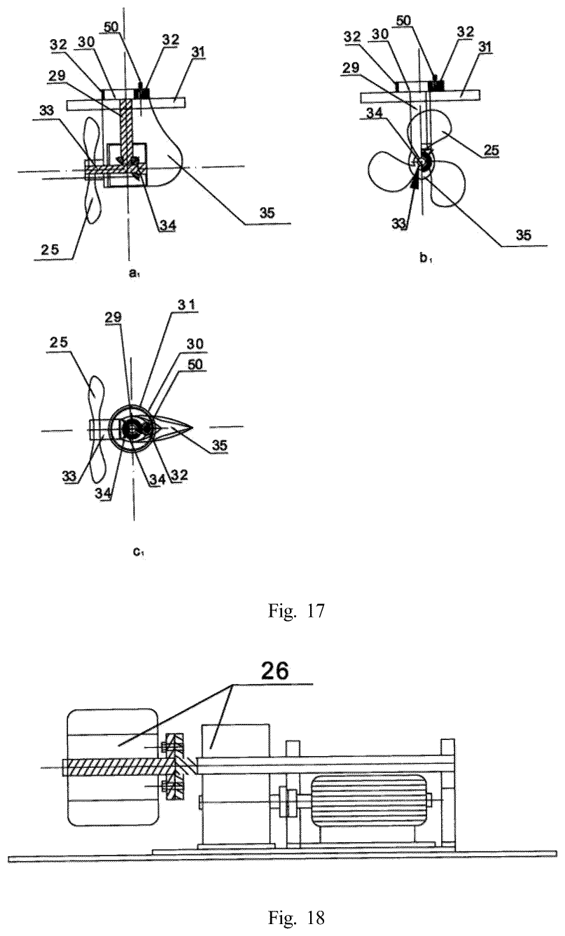

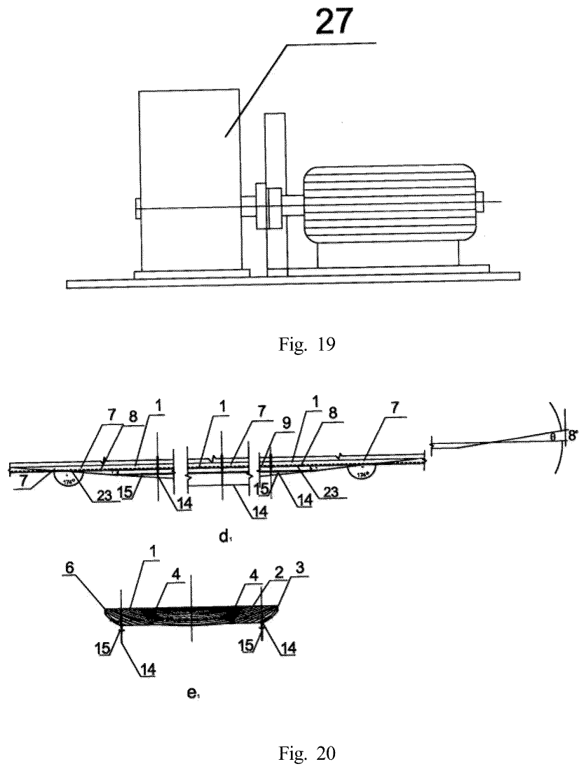

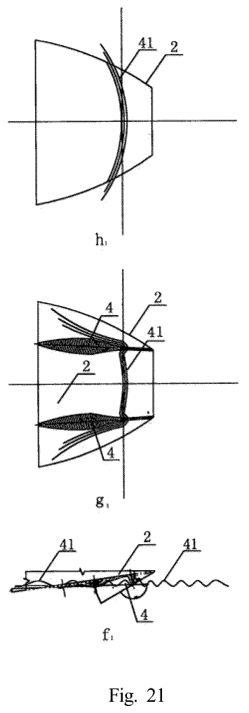

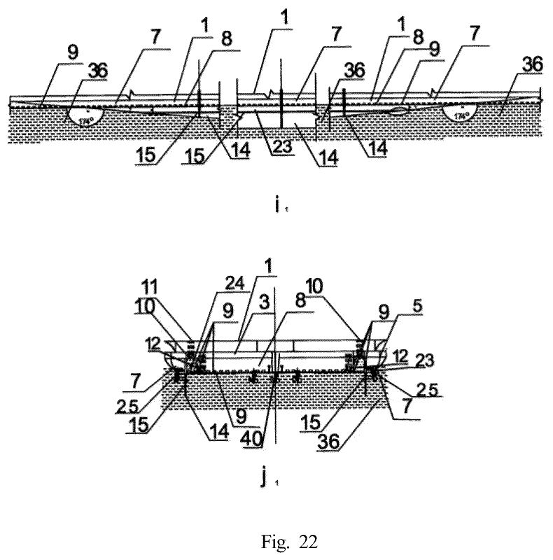

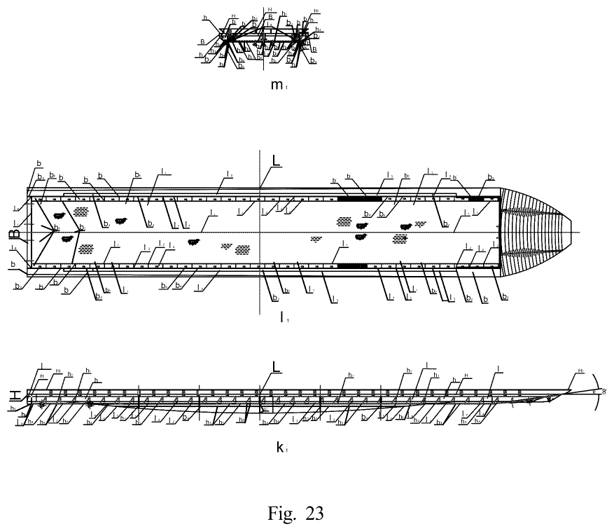

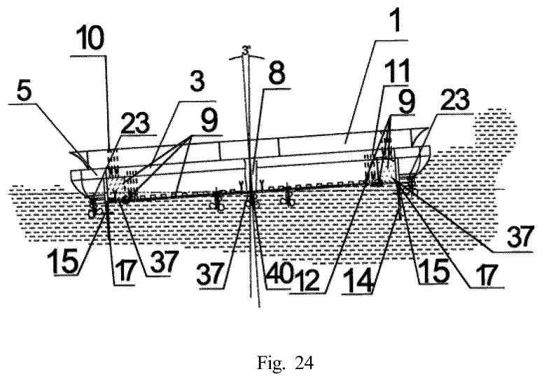

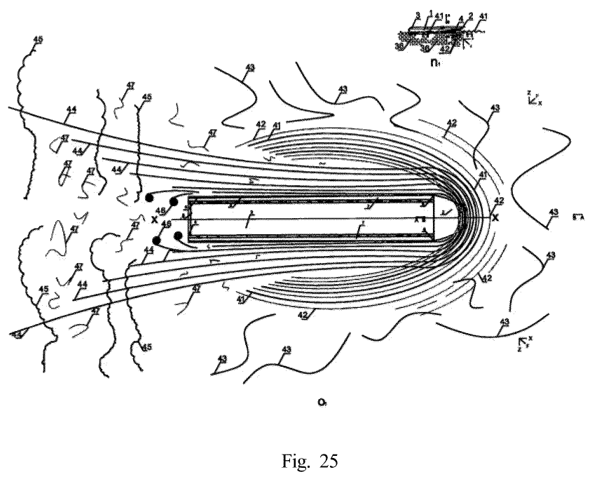

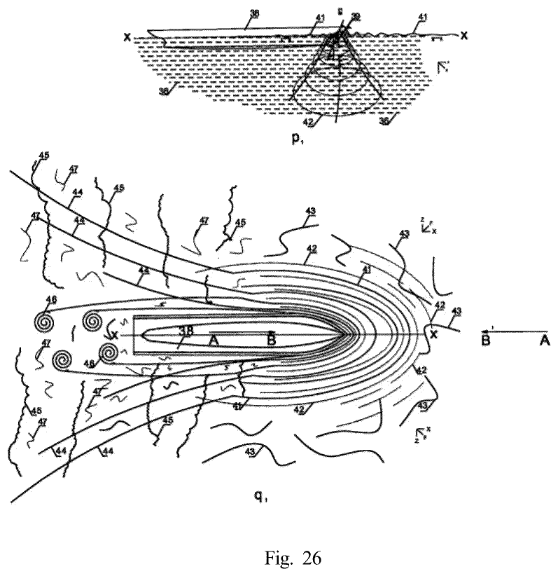

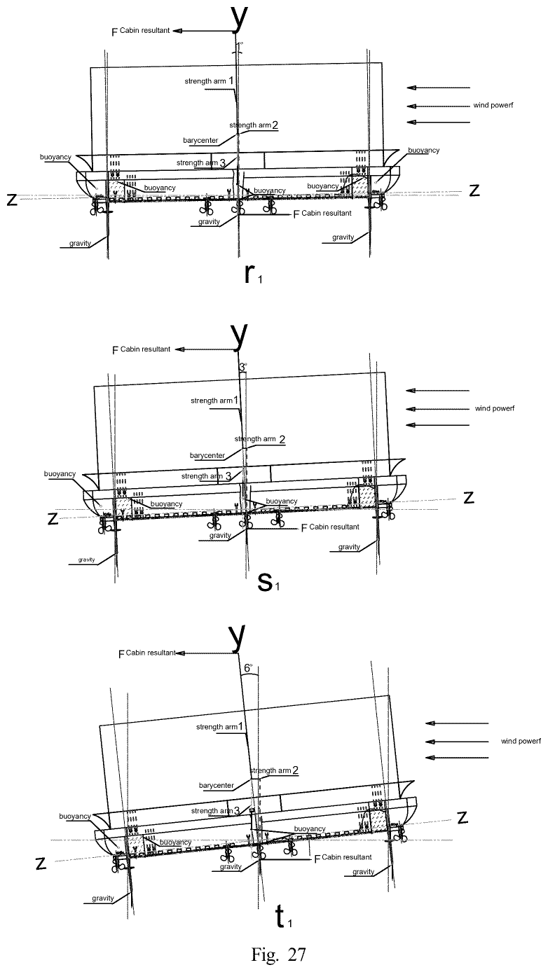

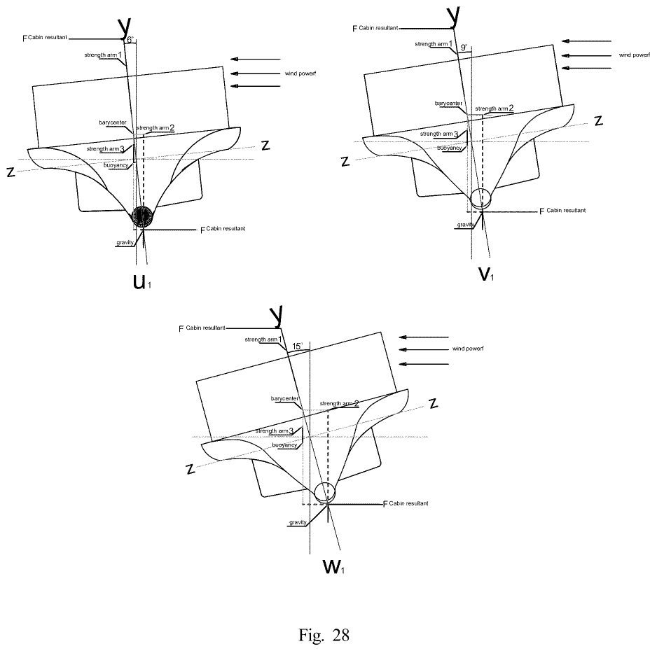

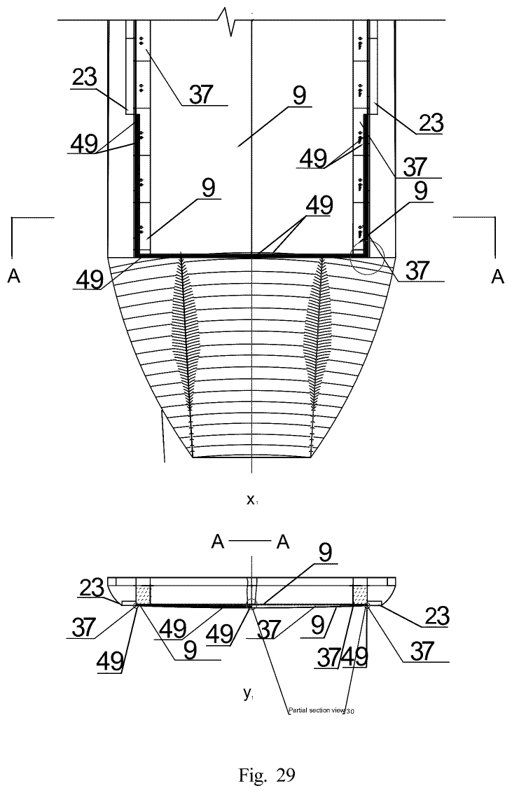

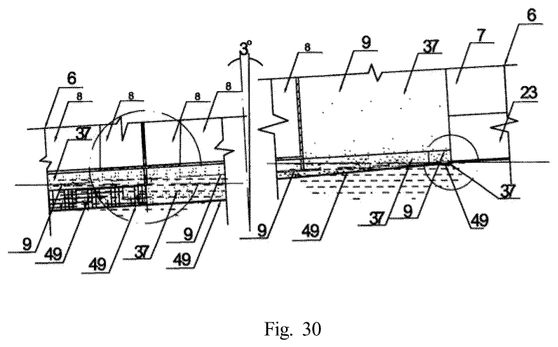

One new type ship, forecast of dual flows conversion force and buoyancy distribution, the application and the methods of process the reduce resistance technology to the ships; the forecast of cache vector value affect the navigational speed of the ships; the ship body achieve the purpose of ships process that reduce resistance through mutual conversion of air flow and water flow; change the existing ship body structure from the whole set, concentrate and distribute the whole set gravity and buoyancy on the depth which on the same one plumb line and convert to the horizontal incline to up section, transverse front, back, left and right overlay status horizontally distributed; according to Archimedes theorem “Ships buoyancy size equal to the weight of the ship body displaced same volume water; the gravity and buoyancy of the ships are same size and reverse direction, and both forces should act on the same one plumb line”.

### BACKGROUND OF THE PRESENT INVENTION

The existing single body ship body, dual bodies ship body, triplet bodies ship body and multiply bodies ship body, we regard these structures of the dual bodies ship body, triplet bodies ship body and multiply bodies ship body as that, gravity and buoyancy horizontal transverse left, right or front and back overlap, assemble multiply ship bodies or designed to dual ship, triplet ship bodies and multiply ship bodies structure, distribute the gravity and buoyancy of the total mass on horizontal transverse front, back, right and left overlap status, divided the total mass into two sets, three sets or multiply sets, added the horizontal transverse buoyancy area, the gravity of the total mass still on the buoyancy cabin of the vertical underwater; make the dual bodies ship as the sample, up of two buoyancy cabin are two pieces slice bodies, suppose to design these two slice bodies to be oppositely thinner slice bodies, reduce the incoming water resistance so; thus the total mass still be distributed on the underwater two buoyancy cabins, under the situation that contrast the single body ship at the same mass, the dual bodies ship body is divided the total mass into two sets, then design the underwater buoyancy cabin to be longitudinal streamline structure, lift the whole set deck cabin to up of the water level, able to expose two slice bodies, do best to reduce the transverse section area of two slice bodies and two buoyancy cabins, reduce the incoming flow resistance area, reduce the rub resistance, sticky resistance, make the buoyancy cabin oppositely able to generate a certain rising force when ship body accelerate navigating, lift up ship body, reduce the wet surface area, reduce the rub resistance, reduce sticky resistance, oppositely able to reduce a certain resistance, improve the navigating speed, opposite to the single body ship, the navigating speed of dual bodies ship will be quicker when add the same power and accelerate navigating, oppositely it still able to add the deck area; dual bodies or triplet bodies ship body only suitable to smaller size ships, just for the application of the ships with special requirements; the practice is large scale cargo ships, the large scale ships still adopt single body structure.

The gravity of the single body structure ships all are concentrated at the same underwater depth on the same one plumb line; make the existing ball nose bow single body ship as sample, it has lower gravity, lower buoyancy center, oppositely able to keep stable center of ship bodies, able to improve the stability, but deeper draft, deeper draft, big wet surface area, bigger rub resistance and big stick resistance, but the bow opposite to the incoming flow incidence θ1 angle ≥67°, bigger incidence in picture 1-a-b, big transverse section area, big resistance; the set nose bow at underwater, the performance of the nose bow is solve the pitch, pitch and heel problems which generated during the ships navigating, generally called it kowtow; the ship generated the wave making resistance during navigating, the bow wave peak and the stern wave valley alternately generated pressure difference caused pitch and aback to make the resistance added value; the wave making resistance which generated by the ball nose bow at underwater, the wave is three dimensional, the size of up and down wave of the bow wave and the stern wave are difference, period is not according, only control the value within navigating speed size range make the wave valley of the up wave and wave peak of down wave to overlap to reduce the pressure difference between the wave peak and wave valley, make the front and back pressure difference of the bow wave and the stern wave reduced, and kept within a certain navigating speed range, then can reduce the wave making resistance, then can solve the pitch and aback problems; so need to control the size of navigating speed value within a certain range then reduce the pressure difference value before and behind the bow wave and stern wave, so very difficult to increase navigating speed; main are bigger resistance value which generated by the draft depth.

### SUMMARY OF THE PRESENT INVENTION

One new type ship, dual flows conversion force and gravity, the way and method that buoyancy distribute on the ships to process the application and the structure; concentration distribute the total mass gravity and buoyancy on the depth which on the same one plumb line and convert to the horizontal incline to up section, transverse front, back, left and right overlay status horizontal distribution, utilize the bottomless air cabin to completely isolate ≥80% rub resistance of water to the ship body, utilize the stick resistance to reduce the ship body resistance; use 25%~35% of the energy with the same power supply to axel flow air compressor or air compressor work, the generated air flow and water flow mutually convert to be dual flow conversion force, make it raise navigating speed ≥70% under the premise that under the same power, achieve the purpose that dual flows conversion force; able to reduce ≥65% energy of on water ships energy consumption; comprehensive improve the navigating speed and stability of ship body through the gravity of the ship body attached structure object gravity block, the gravity of water, negative pressure restrain of air cabin, buoyancy of water and atmosphere; improve the anti storm level of the ship body to ≥level 17; added 50%~100% of deck area; build the better base of combine of utilize the sweep wind force and the dual flows conversion force of the flat structure ship body of this invention.

Utilize the combine of Karman Vortex Street and fishtail jump skirt to reduce the wave making resistance and incline wave resistance; make the resistance convert to the push force which maintain navigating speed; utilize the air leakage air sac to reduce the ship body resistance; utilize the flexible type gravity block attached structure to keep the ship body stable balance, utilize the combine of sweep wind force and the dual flows conversion force of the flat structure ship body, use 25%~35% of the energy with the same power supply to axel flow air compressor or air compressor work, able to make the large scale ships navigating at 10-25 knots navigating speed under the premise that not use impellers.

### I Cache Vector Value Affect the Navigational Speed

1, The cache vector value of this invention, mean that, the energy value which gradually accumulate and cache in the water behind the energy spreading through water when ship body navigating; the ship body is the floating structure object between air and water, part of the ship body above the water on the free liquid level, one part underwater; ship body kinetic energy mutually excitation on the water level, still has wind mutually excitation the ship body and water, no other structure objects restrain the ship body rock when ship body navigating, the kinetic energy when ship body motion also will generate the wave making, the wave making will bring resistance added value; the wave has multiply types, such as gravity wave, capillary wave and others, the storm, swell and others, the wave is three dimensional, is the cache vector value, the cache vector value gradually release to be resistance; the factors of the ship body been excitationed when navigating on the sea are many and complex; make the existing ball nose bow single body structure ship body ship as sample to analyse and contrast the flat structure ship body, the distribution of the gravity and buoyancy of the single body ship body concentrate at deep underwater, when the ship body navigating motion, the picture 3-f-g, the vector marks on the picture (A→B), the bow type V incidence θ angle≥67°, set Δ, A, B, C and θ₁ angle corresponding to ∠A·sin 67°:∠B·cos 23°, ∠A>∠B, vertical axel y axial>horizontal axel x axial; because 80~90% of the resistance all under the vertical water line concentrate the depth on the left and right both sides transverse horizontal z axial and longitudinal horizontal x axial, the bow opposite to the incoming flow need divided out the resistance of two components, so the bow need split out 80%~90% incoming flow water to distribute to both left and right side when ship body navigating motion, the buoyancy back ratio between the gravity back of vertical axel y axial and horizontal axel x axial is sin·A value>cos·B value; according to energy conservation law, how many kinetic energy the ship body load on the water, then how many vector value of generated counter force; ≥85% of ship body of single body ship body at the deep underwater, form the cache vector value far behind opposite around incoming flow, form the same counter force released cache vector value, represented out the wave making on the bow type V tip head higher than the horizontal, the picture 3-f-g; because the ship body gravity concentrate at deep underwater thus bigger generated vector value, more bigger loaded resistance value of sin·A of counter force on the ship body unit area; big ship body depth wet surface area, big rub resistance, bit stick resistance, low ship body gravity, bigger upward restrained force during the navigation, ≈15% of the acting force of ship body kinetic energy loaded on the water able to generate rising force, the ship body unable to generate bigger rising force, unable to keep higher navigating speed under the premise that under the rated power; the opposite incoming flow resistance when ship body navigating at the even speed, part of it directly form the resistance which make the bow type V tip head as circle center, part water transmit and spreading around under the inertia performance through wave type, the spreading water partial collapse and sinking under acting of gravity, part of it form the cache vector value far behind the incoming flow through the wave making or the wave breaking type; when the ship body continue navigating, the counter force of the incoming flow far back released cache vector value opposite to the bow incidence θ angle≥67° and opposite overlap with the ball nose bow type S curve and form the circling resistance; thus the stern because the ship body forward displacement, the bow make the front water forward push and split out, the water which make the bow tip head as circle center, the around water is higher than horizontal, formed the cache vector value, picture 4, thus the water behind the stern form the stern wave because the ship body forward displacement, the stern wave is lower than the negative value of horizontal, form the pressure difference value before and behind the ship body; also because the incoming flow far back cache vector value of the bow type V tip head released, make the three dimensional type of the wave making or the wave breaking transmit to both left and right side of ship body to fill the negative value water field behind the stern, form the stern wave, the transverse wave, the vortex and the turbulent flow to caused the resistance added value, here the size of the resistance added value based on the ship bod draft depth and size of transverse section area and size of the incidence θ₁ angle, the ratio between the displacement distance of the body within unit time and the speed; analyse through macroscopic view, view form this area, the size of this one water field wave range based on the size of difference value between wave peak and wave valley; small wave range which close to bow type V tip head, big difference value between wave peak and wave valley, big far behind the incoming flow wave range which far away the bow type V tip head, small difference value between the wave peak and wave valley; these acting force and counter force represent the direction and size of the energy transmission through wave type; make this inference combine with the ship body draft depth and size of the incidence θ₁ angle, the output power size when ship body navigating and actual navigating distance then can calculate out the size of power and speed ratio; deeper single body ship body draft depth and bigger incidence θ₁ angle, big far behind the incoming flow wave range which far away the bow type V tip head, bigger transmit energy; in the macroscopic, the whole water field push the ship body displacement to behind of the bow under the cache vector value released counter force, it is the ship body displace toward back of the bow along with the whole water field; it is make the people sit on the ship as the coordinate and the view with the water flow and feeling the ship body is move forward, the people can't see the visual displacement distance that ship body displace to back of the bow during ship navigating; this is the not achieved displace distance that actual navigating speed in the unit time; only the longer time and size of the longer distance ratio can know the size of output power navigating distance in actual unit time; single body ship body speed oppositely lower, but big energy consumption, the energy all consumed in that need divide the depth underwater water resistance and overlap with the far behind the incoming flow released counter force of cache vector value and form the circling resistance; bigger ship body draft depth and bigger incidence θ1 angle, more bigger consumed energy, need add power above ≥3 times per improve one knot navigating speed, bigger consumed energy if under the accelerate speed navigating situation.

2, The flat structure ship body compare to the single body structure ship body, is make the total mass gravity and buoyancy all concentrate distribute on the same one plumb line depth underwater to transmit to be horizontal above surface transverse front, back, left and right overlap status horizontal distributed, form the flat structure ship body, picture 2-c-d-e contrast the draft depth of the single body structure ship body, the draft depth of the single body structure ship body only ¼~⅕ of the single body ship body, because the total mass distribute above the horizontal, so the bow opposite to the incoming flow transverse section area increasing, the bow opposite to the incoming flow resistance distribute on the transverse section; firstly make the partial resistance setting of the incidence θ angle 3°~15° . . . °, combine with the buoyancy of water to make the resistance convert to rising force; small draft of the flat structure ship body, then combine with the setting of the bow incidence θ angle 3°~15° . . . °, able to generate bigger rising force opposite to the single body structure ship body during accelerate navigating, it is convert the depth underwater resistance to be the displacement distance within the unit time through the setting of the flat structure ship body, thus raise the navigating speed; fewer consumed energy opposite to the single body structure ship body, small ship body kinetic energy generated vector value, small released cache vector value, smaller counter force opposite to ship body overlap resistance; then analyse the flat structure ship body horizontal transverse section area increasing in the macroscopic, the bow opposite incoming flow resistance distributed on the transverse section, in fact, under the premise that same water displacement, the flat structure ship body opposite incoming flow transverse resistance area 40%~45% smaller than the single body ship body depth underwater transverse resistance area; also because the draft depth of the flat structure ship body only ¼~⅕ of the single body ship body, thus reduced ¼~⅘ depth underwater resistance; the flat structure ship body opposite the setting of the bow incidence θ angle 3°~15° . . . °, picture 5-h-i setting: Δ a, b, c, the incidence θ angle corresponding to ∠a·sin 8°~15°:∠b·cos 82°~75°, ∠a is 1/10~⅕ of ∠b; because the incidence θ angle resistance ∠a<resistance 85% ∠b resistance vertical on horizontal axel y axial <resistance of the horizontal axel x axial; the bow transverse left and right shipboard draft line x axial inward to be included angle, set Δ, a′, b′, c′, ∠a′ sin 40°:∠b′ cos 50°, ∠a′∠/b′; means the vertical axel y axial<horizontal axel z axial and vertical axel x axial<horizontal axel x axial; then combine with the bow incidence θ angle 3°~15° . . . ° setting, so ∠b make ≥70%~80% resistance to convert to rising force through buoyancy of the water; also because the transverse section area is ½~⅗ of the single body ship body, thus also reduced ½~⅖ of the section area resistance; three component resistance vector value, the small angle θ angle 3°~15° . . . ° of the ship body accelerate navigating able to generate bigger rising force, smaller generated vector value opposite to the ship body kinetic energy, smaller counter force released cache vector value, small unit area loaded ship body gravity ∠a·sin, small wet surface area, small rub resistance, small stick resistance, small restrained force of the ship body during navigating, combine withe buoyancy of the water convert the partial resistance to be rising force; bigger displacement distance within unit time opposite to the ship body accelerate navigating.

3, The flat structure ship body horizontal above surface transverse front, back, left and right overlap to distribute gravity, position of buoyancy and size value, picture 6-j-k-l make partial ship body gravity kinetic energy generated resistance through small angle setting of the bow incidence θ angle 3°~15° . . . °, combine with the buoyancy of water to convert the resistance to be rising force; according to the full load displacement quantity, means the total mass, use M represent total mass, distribute total load M on horizontal above surface transverse front, back, left and right overlap to distribute, make the length L, width W and height H of one stere/m³ as the scale and fix at the 1000 Kg/m³ and as the deck area, make the 1000 Kg/m³ as the total deck area S/m², use S represent area, S/m² as cardinal number, arrange the total mass M load on the horizontal incline to up section, transverse front, back, left and right; make the percentage of 1000 Kg/m³%, ratio between the length and width as the cardinal number of deck horizontal area S/m², formula 1, make the percentage of M % m³=H/m³ as the deck horizontal area of L:B; formula 2 make that total mass M divided by deck horizontal area M/S/m²=H/m³ as the height H/m³ of the min draft depth, make this as the cardinal number of the deck cabin height; divide the draft depth to be multiply levels according the size of the sea status wind level when ship body navigating, reduce the ship body gravity when over a certain wind level, make the whole set ship body sink a certain depth, add the draft depth, keep stability of the ship body; decide the ship body structure shape to distribute the gravity, buoyancy position and size value according to the application, size and displacement quantity of the ships, on the sea or inland river running; the formula 3 decide the size of the deck width B according to that deck horizontal area S/m² divided by length L, S/m²/L=L:B, make this specific value as cardinal number, as the gravity, buoyancy distribute coefficient; table 1 as the calculation reference coefficient;

### The Gravity, Buoyancy Distribute Coefficient Table 1

| M1000 Kg/m³ | Mm³% = S/m² | M/S/m² = H/m³ | S/m²/L = L:B | Remarks |
|---|---|---|---|---|
| 10 m³~100 m³ | 250%~200% | H = 0.4~0.5 | L2.8~3.8:1B | 3~10 m³ equal |
| 100 m³~1,000 m³ | 200%~160% | H = 0.5~0.62 | L3.8~4.1:1B | |
| 1,000 m³~9,000 m³ | 160%~100% | H = 0.62~1 | L4.1~4.4:1B | |
| 1.0 m³~5.0 m³/ | 100%~65% | H = 1~1.53 | L4.4~4.7:1B | |
| ten thousand | | | | |
| 5.0 m³~10.0 m³/ [symbol] | 65%~45% | H = 1.5~2.2 | L4.7~5:1B | |
| ten thousand | | | | |
| 10.0 m³~15.0 m³/ [symbol] | 45%~40% | H = 2.2~2.5 | L5~5.2:1B | |
| ten thousand | | | | |
| 15.0 m³~20.0 m³/ [symbol] | 40%~35% | H = 2.2~2.5 | L5.2~5.6:1B | |
| ten thousand | | | | |
| 20.0 m³~25.0 m³/ [symbol] | 35%~32% | H = 2.5~3.1 | L5.6~5.9:1B | |
| ten thousand | | | | |
| 25.0 m³~30.0 m³/ [symbol] | 32%~30% | H = 3.1~3.3 | L5.9~6.1:1B | |
| ten thousand | | | | |
| 30.0 m³~35.0 m³/ [symbol] | 30% | H = 3.3 | L6.1:1B | |
| ten thousand | | | | |
| 35.0 m³~40.0 m³/ [symbol] | 30% | H = 3.3 | L6.1:1B | |
| ten thousand | | | | |
| 40.0 m³~50.0 m³/ [symbol] | 30% | H = 3.3 | L6.1~6.5:1B | 100 m³/ten |
| ten thousand | | | | thousand, equal |

MM means the total mass M1000 Kg/m³, S means the deck area S/m²;

$$M \% {m}^{3} = S / {m}^{2} , \qquad formula 1$$

$$M / S / {m}^{2} = H / {m}^{3} , \qquad formula 2$$

$$S / {m}^{2} / L = L : B . \qquad formula 3$$

4, The flat structure ship body and single body structure ship body contrast the size of the cache vector value; the draft depth of the flat structure ship body only ¼~⅕ of the single body structure ship body, the flat structure bow levelly look down setting as trapezoid relative to the incoming flow, picture 6-j-k-l from the bow frontier both side to the outer hull boundary to be included angle Δ angle 21°~25°, both side is arc boundary to be bow shape, bow shape chord height h′≥0.3 m~0.5 m, longitudinal from the ship bottom to the frontier boundary is curve external tangency and the bow angle of incidence θ angle to be 3°~15° curve tangency, transverse from the bow to the ship's bow front boundary to both left and right sides of the outer hull, downward to ship bottom to incline extending point of incidence θ angle to be joint point and come to be the oval curve left and right connection, form the curved surface; analyse the resistance size when the kinetic energy of the flat structure ship body generate cache vector value when navigating and the released cache vector value generated counter force to ship body navigating; when the flat structure ship body navigating at even speed, the displacement of the total mass at up of horizontal, the ship body transverse opposite to incoming flow section area increasing; make the bow outer hull to the bow frontier to be trapezoid to form the included angle Δ angle 21°~25° with the ship body, combine with the bow frontier downward incidence θ angle at 3°~15° . . . ° setting to reduce the bow incidence θ angle resistance area's incline surface small angle ≥67° than the single body structure ship body incidence θ₁ angle, the flat structure ship body transverse section resistance area is 40%~45% of the single body structure ship body; also convert the incoming flow resistance to the upward rising force through small angle, this rising force means that the flat structure ship body opposite to the single body structure ship body, reduced ≥75% the restrain force of water to ship body and generated rising force when the ship body upward navigating; then make the partial resistance of the bow frontier along with the middle incoming flow distributed to both side through both side flow distribute plates, reduce partial resistance of the incoming flow; according to energy conservation law, how many kinetic energy the ship body load on the water, then how many vector value of generated counter force, then the water will cache how many vector value; the flat structure ship body opposite to the single body structure ship body smaller cache vector value, smaller released cache vector value, because the inertia of water smaller opposite to the water gravity performance, picture 7-n; the single body structure ship body contrast to the flat structure ship body, picture 7-m partial water and the counter force when the bow navigating come to be the main resistance of the ship body, the ship body draft oppositely deeper, the incidence θ1 angle oppositely bigger, bigger required energy, bigger kinetic energy generated cache vector value, bigger formed resistance; one part of it spreading through the wave making type toward around the bow incoming flow and far behind, form the pressure difference resistance return to ship body around and behind of the bow from the far behind; one part of the water collapse and sinking because the gravity performance, if the sinking water and ship body draft deeper, the bigger incidence θ1 angle ship body, example the single body structure ship body and the ball nose bow ship body oppositely overlap to form the bigger resistance; formed three vector value resistance, these three vector value basic keep not change when the ship body navigating at even speed; the flat structure ship body opposite to the single body structure ship body is make the resistance of these three vector value, picture 7-n, change the resistance value of these three vector value through distribution of the flat structure shape; it is convert the incoming flow resistance to be upward rising force through θ small angle, this rising force only means that the flat structure ship body opposite to the single body structure ship body, upward reduced ≥75% restrain force of water to ship body on the ship body navigating; thus reduced the resistance; the above not include the other air resistance, the tidal waves and attached body resistance bring the resistance variable; the setting of the described flow distribute plate based on size of water discharge quantity, the middle and small scale ships able to install one piece flow distribute plate at middle of ships, or not install the flow distribute plate.

5, The flat structure ship body only ¼~⅕ draft depth of the single body structure ship body, picture 7-m-n, opposite to the section area, it will be ½~⅖ less than the single body structure ship body, the kinetic energy of the flat structure ship body distribute on the horizontal incline to up transverse section, thus the bow opposite to the small angle of the incoming flow incidence θ angle, make the ship body kinetic energy generated vector value oppositely 40%~45% less than the cache vector value, the counter force also 40%~45% less than the counter force, these cache vector value all distributed on the horizontal transverse up section, the release of cache vector value opposite to the flat structure ship body, the counter force of one part of the water and ship body and ship body directly come to be the main resistance of the ship body when navigating, the flat structure bow opposite to the incoming flow incidence θ angle to be the small angle at 3°~15° . . . °, make this part resistance to upward lift up the ship body on y axial through buoyancy of the water, oppositely smaller of the ship body upward restrain force, only the ship body self gravity, the resistance is one added value when the wave making wave peak impact with the bow, now the ship body bow able to upward lift up through the rising force through buoyancy and θ angle small angle, make the resistance of the added value convert to be rising force, oppositely able to keep even speed navigating; compare to the other single body ship body when the ship body accelerate navigating at the same power, picture 26-p1-q1, able to improve ≥30% navigating speed under the same water displacement condition; one part spreading to the incoming flow around far behind the bow through the wave making type because the inertia of the water flow, picture 25-n1-o1, when these cache vector value return to around the ship body and behind of the bow to the stern to form the pressure difference resistance from far behind through wave type and counter force, make the three dimensional wave energy such as the tidal wave or the wave breaking transmit the cache vector value to both left and right side of the ship body to fill the stern behind negative value water field, form the vortex and the turbulent flow and caused the resistance added value; thus the flat structure ship body kinetic energy generated cache vector value need be 40%~45% smaller, the pressure difference resistance which return to around ship body, behind the bow to the stern oppositely less 40%~45%; one part collapse and sinking because the performance of the water gravity, if the sinking water oppositely overlap with the flat structure ship body bow to form the resistance, but the draft depth of the flat structure ship body only ¼~⅕ of the single body structure ship body, picture 26-p1=q1, thus reduce ¾~⅘ depth underwater overlap resistance again, combine with the bow incidence θ angle and transverse section area then will less 40%~45%, oppositely able to reduce 65%~70% of the total resistance value.

6, The size of cache vector value will caused the size of the stall specific value when ship body navigating, the reasons of the ship body stall also are different, they are active stall and natural stall, the active stall relate to the ship body structure and motor; under the premise that same water displacement, the draft depth of the flat structure ship body will be ¾~⅘ smaller than the single body structure ship body, the bow opposite incoming flow transverse section resistance area will less 40%~45%, picture 25-n1-o1, reduce the wet surface area, reduce the rub resistance, reduce sticky resistance, 40%~45% area is the small angle of the bow incidence θ angle opposite to resistance area of the incoming flow, able to generate the rising force when accelerating, reduced the ship body kinetic energy generated vector value, the total quantity able to reduce 50%~60% cache vector value when ship body even speed navigating, when the heavy wind generated tidal wave energy generated vector value overlap counter force return to the ship body around water field then will caused the stall of the ship body; the cache vector value of the flat structure ship body will less 50%~60% compare to the single body structure ship body, picture 16-p1-q1, it will less 50%~60% when counter force return to the ship body around water field, also because the flat structure ship body less 40%~45% than the single body structure ship body, the draft depth of the single body structure ship body ¾~⅘ than the flat structure ship body, the bow opposite the incoming flow transverse resistance area 40%~45% bigger than the flat structure ship body, the bow opposite incidence θ₁ angle ≥67° bigger than the flat structure ship body incidence θ angle 3°~15° . . . °≥8 time, the opposite stall ratio will be 60%~70% bigger; these are estimate value opposite to the ship body structure, not include the structure above the wet surface area bring wind load ratio.

### II Dual Flows Conversion Force

(1) The dual flows conversion force of this invention, means that, both different fluids mutually convert to generated acting force; because the ship body is the floating structure object between air and water, part of the ship body above the water on the free liquid level, one part up the water, one part underwater; ship body kinetic energy mutually excitation on the water level, still has wind mutually excitation the ship body and water, no other structure objects restrain the ship body rock when ship body navigating, the kinetic energy when ship body motion also will generate the wave making, the wave making will bring resistance; the wave has multiply types, such as gravity wave, capillary wave and others, the storm, swell and others, the wave is three dimensional, is the cache vector value; the flat structure ship body only ¼~⅕ draft depth of the single body structure ship body, thus reduced ¾~⅘ of the draft depth, picture 2-c-d-e; because the ship body is the floating structure object between the air and water, smaller draft depth of the flat structure ship body, will generate bigger transverse rock and longitudinal rock when has wind storm, caused the unstable factors increased, generate the resistance added value at the same time, if the cargo uneven when storing then will caused the ship body side overturn, need guarantee the ship body not side overturn, solve the transverse rock and longitudinal rock to keep stability of the ship body, need reduce the gravity, lift up buoyancy center, reset the distribute gravity, gravity center, buoyancy, buoyancy center of the ship body, picture 23-k1-l1-m1, downward extension from the bow and the outer hull to the stern both side deck cabin, add the bottom stowage water cabins; picture 9-q-r, the height of the bottom stowage water cabin make H as cardinal number to multiply by 2 times height of deck cabin, 2·H is height of the bottom stowage water cabin h; the length of the bottom stowage water cabin from the bow outer hull to the stern both end as the bottom stowage water cabin, the bottom stowage water cabin frontier bow outer hull down with the stern incidence θ angle extending line to the bottom stowage water cabin bottom to be the same one θ angle 3°~15°; the width of the bottom stowage water cabin is 8%~13% of the whole set deck cabin B width is each width of both side of the bottom stowage water cabin b; add gravity cabin (cargo cabin) at middle of both side the bottom stowage water cabins, each obligate 3%~5% of deck cabin B width between both side of gravity cabin and the bottom stowage water cabin as the width of the air cabin b′, the rest width b1 as the width of the gravity cabin b1, make the center line of the deck cabin B width as axel line to equal divide the width of the gravity cabin b1 toward both side; the height of the gravity cabin make the deck cabin H/m³ as cardinal number to multiply by 3·H times height, then subtract 2%~4.5% of 3·H times height and as the height of the gravity cabin h1; the length of the gravity cabin make the stern end inward indent 1.1%~2%/m of the length of the bottom stowage water cabins the gravity cabin stern to the bow outer hull downward transverse section and the bow incidence θ angle extension surface to form the same angle curve, this is length of the gravity cabin l1; make the center ling of the deck cabin width B as the axle line, outer downward extend 5%~8% of the gravity cabin 3·H times height of the gravity cabin and set the center vertical isolate plate h2, both left and right boundary of the gravity cabin set the height of 3·H times deck cabin as the vertical air balance plate h2, one block vertical isolate plate l1 and two blocks vertical air balance plate l1 which length front and back equal to the cabin bottom 1 of the gravity cabin; make the internal side vertical surface of both side of bottom stowage water cabins downward extending, picture 10-s-t-u, from the downward bottom line of the outer hull and the incidence θ angle form the same angle joint point to the stern, add the same height of deck cabin ≥H height, set the boarding h3 for the boarding h3 height, seal front and back surface among both side bottom stowage water cabins and gravity cabin, front seal plate and the bow incidence θ angle extension line to form the same angle curve, the back seal plate and the cabin bottom of the gravity cabin are the same height same vertical surface seal plate, set the dual flows conversion plate between the down of the cabin bottom of the gravity cabin and same height with the boarding h3, form the non bottom air cabin h3 which bottom no solid materials sealed, the whole set bottomless air cabin is open cavity which circled by solid materials, according to the inverted open container buckle on the water, form the bottomless air cabin h3, utilize the liquid level as one surface of seal close loop cavity, form one close loop cavity which able to open and close; bottom of the bottomless air cabin lower than horizontal with a certain depth; the bottomless air cabin hereinafter simply called air cabin h3; air is compressed liquid, the cabin bottom of the air cabin air intensity of pressure P=P₀+ρ_{water} gh/s², the cabin bottom of the air cabin and ρ_{water} gh depth are equal, the air cabin volume represented by L/m³, the horizontal area represented by S2, P0=1 standard atmosphere, the air in the air cabin equal to: the air cabin volume is L/m³·ρₐᵢᵣ gh/s²; P0+ρ_{water} gh/s²=P0+L/m³·ρₐᵢᵣ gh/s²>1 standard atmosphere, the size of the value based on the size of draft depth h; the whole set air cabin width is 70%~80% of the deck cabin B width as the width of the whole set air cabin width bΨ, the whole set air cabin make air layer completely isolate with a certain thickness, the contact space among water, deck cabin and the gravity cabin's cabin bottom; the whole set air cabin longitudinal divided into four pieces air cabins, two pieces air cabin of the cabin bottom of the gravity cabin represented by bΨ; make the interval which make 10%~20% of the front and back longitudinal length from the stern gravity cabin vertical surface to both side air cabin b′ of the stern, isolate to be multiply air cabin l2, the vertical isolate plate h1 height level to the cabin bottom of the gravity cabin, down boundary of the vertical isolate plate able to incline one angle behind the stern based on different ship isolate plate, picture 11-v-w-x, length of l2 is length of each one air cabin; through the above distribution oppositely reduced the gravity, rising the floating center, partial floating center higher than partial gravity, and the acting force of this floating center opposite to the added buoyancy out of ship body the deck cabin and cabin body, the three dimensional structure space out of ship body cabin body directly make air as medium to increase buoyancy support force increase floating center, the acted surface of the support force surface at the cabin bottom of the deck cabin, form both side two force arm through air to lift up both side bottom stowage water cabins and middle gravity cabin.

(2) How to utilize the flat structure ship body to achieve the performance of dual flows conversion force and keep the stability of the ship body; keep stability of the ship body at the same time of reduce water resistance of the flat structure ship body is one important nodes; because small draft of the flat structure ship body, easily been shocked by the different size storm and stall; need overcome the strike of different size storms, from the stern both side bottom stowage water cabins outer side inward each retract 1.5%~2.5% width of the deck cabin B width, longitudinal make the bow and the outer hull to the stern to form streamline type structure, reduce the rub resistance in the boundary layer, picture 10-s-t-u; make the indented joint point under the deck cabin as the joint point, ½ position of downward and inward to the bottom stowage water cabins b bottom line width to be joint point, up and down side connected by arc curve, joint point at the bottom stowage water cabins b bottom line width position and set the water seal cabin width, then downward extend the deck cabin H times height as the water seal cabin h4 height and same height with the boarding h3, the water seal cabin length make the center between two points which make the stern ends and the bottom line of 3·H times deck cabin height of bow incidence θ angle extension line as joint point to be axle line, side both ends inward indent 5%~8%/m of the bottom stowage water cabin's cabin bottom length, this is length of the water seal cabin l3, both ends of the water seal cabin downward to the center cabin bottom from the bottom stowage water cabin's cabin bottom, connect to the bottom stowage water cabin's cabin bottom through ratio of height-length ratio 1 m:6 m as joint point curve, the described the water seal cabin bottom downward, set the height of pressurize wall h5 at the height where the bottom stowage water cabins both side internal boarding h3 bottom line downward extending increase 0.03 m~0.25 m; start from the both side pressurize wall down bottom line, the horizontal length line from the stern end to the bow outer hull and the bow incidence θ angle extending line to be joint point as the length of the pressurize wall l4; make the horizontal height line of the pressurize wall h5 as the string, the axel line which make the center of the water seal cabin l3 length vertical downward extending 5~3 H times deck cabin height as the string height h″, the string height which set as vertical bow shape gravity block h″, parallel at longitudinal left and right two blocks gravity block, the distance between both points of the string length of the gravity block make the joint point of the water seal cabin both ends cabin bottom curve joints is string length of the gravity block l5, longitudinal transverse section of the gravity block is thin sheet body, thickness 0.005 mm~0.7 m is the longitudinal width of the gravity block b4, make the string of the both side of the gravity block as start point, 2.2~1.8. H times height h6 of longitudinal downward extending deck cabin as the joint point to set the horizontal water board string height h6, the horizontal water board mutually vertical to the gravity block, longitudinal both side each wide 0.2 m~1.6 m as the width of water board b5, longitudinal length make the distance between front and back bow shape sting side of the gravity block as the length of the water board l6, the height h7 of the water board, means the up and down thickness 0.005 m~0.35 m, the size and draft of both side width of the water board increase or reduce according to the structure height above the waterline, size of the load gravity distribute value and different position; the pressurize wall h5 vertical surface open air balance port which downward extend 0.02 m~0.1 m height from boarding h3 bottom line as the joint point, make front transverse vertical isolate plate h1 line of each one air cabin l2 as joint point, backward horizontal extend 1.5%~3.5%/m of the air cabin as length of the air balance port l7, width is the width of the pressurize wall b4, set the air balance port, the air balance port is rectangle through hole, height of the air balance port h8 is 0.02 m~0.2 m; open two holes at top of each one air cabin b′ at both side of longitudinal and open two holes on two air cabin's cabin bottom, one is air inlet hole, one is air outlet hole, install valve at the same time, the air inlet hole connect to the axle flow air compressor or the air compressor; picture 13 make the stern gravity cabin seal plate down boundary height line as joint point, set the dual flows conversion plate, the length equal to the width of the bottomless air cabin b_{ψ}′, the up and down width represented by height as h9, 2%~4% of 3·H height as height of the dual flows conversion plate h9, the side profile is the horizontal downward and backward arc curve, form the dual flows conversion plate curve body which arc curve body is “Archimedes helical line”, make the dual flows conversion plate 18 transverse side and the stern gravity cabin seal plate down boundary height line as joint point, use the hinge at the connect position, transversely connect multiply pieces hinge structure, and make the up and down revolve shaft of the hinge as axial to adjust the up and down stroke of the dual flows conversion plate 18, transversely set and install 2~20 pieces hydraulic push-pull rods, the shock absorber and the link rod on the concave surface of the dual flows conversion plate, connect the shock absorber and the shock absorber link rod on the concave surface of the dual flows conversion plate, one end of the link rod connect and fix on the revolve shaft of the stern gravity cabin vertical seal plate surface, another one end of the link rod connect the hydraulic push-pull rod, another one end of the hydraulic push-pull rod fix on the stern gravity cabin vertical seal plate surface, the convex surface of the dual flows conversion plate is the curve air sac.

(3) When the ship body float navigating on the free liquid level, the ship body mutually excitation on the water level, and the wind mutually excitation the ship body and water, besides, no other structure objects restrain the ship body excitation; small draft depth of the flat structure ship body, floating on the liquid level then unable to anti the storm excitation thus stall, the ship body gravity and buoyancy center not concentrate on the center vertical line, the gravity and buoyancy center are diffuse; how to distribute the gravity and buoyancy center and the position of gravity and buoyancy center to improve stability of the ship body? add the bottom stowage water cabins h with same volume at longitudinal both side of the flat structure ship body to reduce the gravity, picture 9-q-r, but the gravity at both side, when the storm attack one side of the ship body, the gravity deviate to another one side at the moment of the ship body one side lift up, another one side moment gravity oppositely increased, the gravity incline to one side and downward deviate to caused the ship body stall; so add the gravity at the center of the ship body, set the gravity cabin h1 to transmit the gravity position to balance both side gravity of the bottom stowage water cabins, the cabin bottom of the gravity cabin lower than the height of the bottom stowage water cabin's cabin bottom, thus further more reduce the gravity of the ship body, adjusted the gravity position and increased the stability; remain the air cabin b′ among both side of the gravity and the bottom stowage water cabins to lift up buoyancy center, picture 10-s-t-u, part of the buoyancy center higher than part of gravity, and the acting force of this buoyancy center is the added buoyancy opposite to out of the ship body cabin body, it is the three dimensional structure space out of the ship body cabin body which directly make the gas as medium added buoyancy support force lift up buoyancy center, the support force surface at the cabin bottom of the deck cabin; to utilize the dual flows conversion force to reduce the rub resistance and sticky resistance of water to the ship body, set the structure that air layer isolate the rub resistance of water to the ship body, downward extend at the bottom stowage water cabin's cabin bottom to add the water seal cabin, the water seal cabin added the buoyancy at both side, the ship body will not side overturn because the attack of the storm, improved the stability of the ship body; make the cabin bottom of the water seal cabin as the bottom line height, seal the front and back air seal which at both side of the bow and the stern, formed the whole set air cabin b_{ψ}′, able to achieved ≥80% wet surface area, completely isolate the water out of the ship body cabin body external surface through the air layer; the stern gravity cabin vertical seal plate boundary to the boarding h3 has height difference, set the dual flows conversion plate 18 to fill the height difference between the stern gravity cabin seal plate down boundary to the boarding h3 and water sealing cabin h3 bottom line, picture l3, make the whole set ship body bottom according to the boarding height, form the whole set air cabin b_{ψ}′; when the air input into the air cabin achieved 95%~99.5% of the unit volume, the ship body is relatively balance under the status in static water area, this is the min draft line of the ship body; because the gravity and buoyancy of the whole set ship body are diffused, not on the same one vertical center line, the gravity and buoyancy distribution of all transverse horizontal points are not absolute equal, this caused the cabin bottom of the air cabin not on the same one horizontal line, the air will flow out from the one side or one core where more close to the water level, make the ship body unstable, need pass through multiply times opposite one side or one corner air flow out, reduce the air in the air cabin, the water enter into the opposite unit volume to balance the partial gravity difference then can keep the ship body balance; when the ship body start navigating, make the stern dual flows conversion plate upward hoist 0.5%~1.5% height through the shock absorber, the link rod and the hydraulic push-pull rod, open the valve through the air inlet hole on top of each one air cabin and make the axle flow air compressor or air compressor circling input air into the air cabin, the air pressure in the air cabin is >1 atmosphere out of the cabin body, the air pressure increasing; when the input input air in the air cabin achieved and exceed 95%~99.5 unit volume, the gas will be discharged from the one port from more close distance outlet, make ship body able to displace toward one direction; behind lift up the dual flows conversion plate during the ship body start navigating, make the moment air cabin internal pressure reduced behind the gas discharged, the stern and dual flows conversion plate moment falling and caused the stern overturn, when the air repeat circling input the air cabin, it will generates high frequency shimmy, the ship body stern overturn caused the pitch and make the ship body loss stable, make the resistance increased value; generate damp buffer through the dual flows conversion plate convex curve body air sac and the shock absorber on concave surface, able to reduce the high frequency shimmy, stern overturn; the buoyancy of the flat structure water seal cabin is the buoyancy in the ship body cabin, unit volume under the seal condition is fix value, not affected by the external variable thus change the size and position of the internal unit volume fix value; at the moment of that the stern generate stern overturn, the support force opposite to the buoyancy of the water seal cabin able to reduce the up and down stroke range of the stern overturn, keep navigating speed at the same time of keep stability of the ship body; the described dual flows conversion plate (18) able to control and affect the navigating speed of the ship body, the counter acting force which discharged through the dual flows conversion air cabin opposite to the water, the density of the water more 800 times bigger than then density of the air, the ship body will displace at opposite direction of discharge the gas, the counter action force of the air flow opposite to the water to push the ships reversely move, the generated displacement is under the action of the dual flows conversion; if the discharge gas is opposite to the air, also able to reversely displaced, merely the counter acting force will less ≤800 times; the flat structure ship body ≥80% are floating on the air cabin gas, stick resistance, combine with the bow incidence θ angle form 3°~15° small angle, then further more input the air which over the unit volume when enter into air cabin, the displacement distance and speed within unit time will further more increased, in theory, under the premise that not use impeller, when continue make infinite increasing power input unit volume air into air cabin, the speed will be infinite big under the situation that not considering other resistance factors.

(4) For the gravity of the flat structure ship body, distribute on the horizontal up transverse front, back, left and right overlap status, the gravity and buoyancy center is diffused, it will generate unstable balance when has bigger storm, transmit the diffused gravity and buoyancy center to the gravity block of the air cabin b′ through add gravity block, make the bow shape gravity block chord length equal division line as the center line to the lowest height arc boundary form the highest buoyancy center and lowest gravity with the buoyancy of the ship body cabin body external three dimensional structure space both side air cabin b′, inquiry the ship body structure of Archimedes theorem, concentrate transmit the diffused gravity and buoyancy center to the oppositely highest buoyancy center of ship body cabin body outer three dimensional structure space both side air cabin b′ and the opposite lowest height arc boundary gravity center gravity block; both side two gravity and buoyancy at equal size and opposite direction, and both forces act on the same one plumb line; small draft depth of the flat structure ship body, no other structure objects restrain the ship body when navigating, will stall because the storm excitation; make the horizontal height of the pressurize wall h5 bottom line as string, picture 11-v-w-x make the axel vertical downward extending 5~4·H times deck cabin height as string height h″, set the bow shape gravity block 11″ to reduce the whole set gravity, add the wet surface area to restrain ship body; the gravity block is attach body structure, has flexible type gravity block and fix type gravity block and the water board; the flexible type gravity block suitable to special ships, example, need has the higher navigating speed at the same time, small gyration shift distance, quick gyration, has better navigation stability at the same time of the flexible gyration, better operation, able to keep the stable characteristic of the ship under the situation that various sea situation, a little higher opposite cost; now make the fix type gravity block and the boarding plate as sample, set the sting height of the gravity block, means that the draft depth of the gravity block need be increased or reduced according to the structure height of the above draft line up deck cabin H1 and the size of load, anti the wind load bring unstable balance; set the horizontal boarding plate string height h6 through extending the gravity block 2.2~1.8·H times deck cabin height h6 as the joint point, the horizontal boarding plate h6 which vertical to the gravity block, means the draft depth of the boarding plate, the horizontal boarding plate and the gravity block are mutually vertical, both side each wide 0.2 m ~1.6 m as the width of the boarding plate b5; the boarding plate b5 horizontal width need be increased or reduced according to the structure height of the above draft line up deck cabin H1 and the size of load; when the ship body one side load the storm incline wave excitation thus generate unstable balance, this will bring the gravity block and the boarding plate lift up, the gravity load of the water between the both side of the boarding plate above to air cabin bottom water level and the cabin body horizontal plane damp restrain the lift up height of the ship body above the boarding plate; when the lift up height and incline degree of the ship body exceed one side air cabin boarding down opposite air balance port, the air in the air cabin will automatically discharge out from the air balance port, combine with the ship body self gravity action then will automatic sinking to recover balance; has three pieces vertical isolate plate s under the gravity cabin cabin bottom, the gravity cabin center isolate plate h2 and both left and right side vertical air balance plate h3 formed four pieces air cabin as the whole set air cabin b_{ψ}′; when the storm caused one side gas discharge unit volume, the opposite another one side b′ air cabin lso will discharge the air which less than unit volume, because the center vertical isolate plate f the air cabin b_{ψ}′ higher than the height of both side air balance plate h3, so another one side air cabin b_{ψ}′ discharge the unit volume gas<one side air cabin b_{ψ}′ discharge unit volume gas, make another one side sinking stroke smaller, one side ship body able to rapidly automatic regulate balance with another one side when return falling, oppositely keep stable and balance; then contrast the gravity and support force of the buoyancy of the other single body ship body, all are distributed on the same axel, they are both opposite force on the same one horizontal line, picture 28-u1-v1-w1, lift up one side a certain time at the moment of the cabin body shocked by the storm, the gravity and buoyancy revolving shift of another one side will make the gravity which vertical axle as the revolve center to revolve at the opposite another one side, this caused the stable center shift and stall; the flat structure ship body has the buoyancy and two gravity with according both horizontal height, one is the buoyancy in the three dimensional space of the ship body, and the buoyancy out of the three dimensional, picture 23-k1-l1-m1, the support force of partial buoyancy is distribute in the three dimensional space air cabin b_{ψ}′ which outer of the ship body cabin body, the support force of partial buoyancy transmit to the cabin bottom of the deck cabin H, partial buoyancy at the cabin bottom of the gravity cabin; thus the support point of both side air cabin b′ support force lower than the buoyancy support height, transmit partial gravity to the water through the air support force of the three dimensional structure space air cabin b_{ψ}′, picture 27-r1-s1-t1, suppose the ship body side moment rising height because storm shocked, the opposite another one side also will change the original height because this and sink a certain height, but smaller opposite sink stroke, it is not revolve along with the vertical axle ling of the ship body, it's revolve center deviate to another one side gravity, gravity of buoyancy revolve along with revolve center, make the ship body keep stable balance; even though no circling air input the whole set air cabin by, one side moment rising height too high when storm shocking, when too big discharge air unit volume increasing through the air balance port, one side will return fallen sinking lower than another one side horizontal height, but another one side will generate incline because too big sinking of one side then will discharge the gas which less than opposite one side unit volume, thus recover the balance of the whole set ship body; if under the situation that high wind continue push the ship body, the whole process is automatic multiply times circling recover balance process, the up and down stroke of the ship body circling based on size of storm, but relative to the recover process of single body structure ship body more smaller up and down stroke within unit time, but quicker recover balance, this is because volume of the another one side discharge gas during every one time circling process relative less than volume of one side discharge gas; One side and another one side is the state of mutually exchange position]; the above process is automatically finish steady state under the natural environment with storm shock; act the dual flows conversion force performance.

(5) The ship will meeting different levels gale, typhoon storm frequently when navigating on the sen and caused the ship unstable factors increasing, for the flat structure ship body, smaller draft depth caused bigger unstable factors, this in one important link, the above described several methods able to act better stable balance performance; when the flat structure ship body meeting ≥level 8 gale, it will occur various different storm, incline wave, tidal wave, caused transverse rock, longitudinal rock and other unstable balance; firstly close the air inlet port and valve which on top of the air cabin b_{ψ}′, picture 15, open the air outlet hole valve which on top of the air cabin, discharge a certain unit volume air, picture 14, lift up the dual flows conversion plate to a certain height through the hydraulic push-pull rod, make the air cabin enter a certain height water, make the whole set ship body reduce a certain height, ad the draft depth of the ship body, then close the air outlet valve, the air cabin still has partial air, now the air pressure in the cavity≈equal to the outer atmosphere; at the moment of the storm push one side of the ship body lift up the ship body, generate the negative pressure at the moment of the water in the air cabin will make the air in the air cabin cavity under the external atmosphere reduce along with water, the water will along with the storm rising to absorb in the cavity and drag the ship body, now, the moment of the ship body one side lift up, the ship body gravity plus the water gravity is >1 storm shock vector thus drag the ship body; then combine with the performance of the gravity block and the boarding plate, the ship body will rising and falling along with the wave peak and wave valley alter rising and falling, but the up and down range of the ship body rising and falling is the up and down range of the vector which <1 storm shock, the opposite rising and falling stroke need be smaller, the ship body able to continue keep low speed navigating and keep the opposite stable balance; when the storm further increase to be above level 17, various different wave height of the storm incline wave and tidal waves higher, these caused the transverse rock, longitudinal rock, vibration and other unstable factors of the ship body further more increasing; the ship will drop anchor and stop navigating under this sea status environment, but for that load more light mass cargo objects and the structure object on deck cabin H1 are higher, some ships will filling water in the bottom stowage water cabins to reduce the ship body gravity, increase the draft depth to anti storm attack, reduce risk, oppositely keep the stable balance within a certain range, but the reduced height with limit, unable to completely solve the risks; some ships not set the bottom stowage water cabins, the risk will be bigger, some will caused the ship body overturn; opposite to the flat structure ship body will firstly close the air inlet port and valve which on top of the air cabin b_{ψ}′, picture 15, open the air outlet hole valve which on top of the air cabin, downward press the dual flows conversion plate to the boarding h3 bottom line height through the hydraulic push-pull rod, fully filling water in the air cabin, then close the air venting hole valve, combine with fully filled water in the bottom stowage water cabins, reduce the whole set ship body to the deck cabin H1 positive and negative ±up and down horizontal, when the storm push one side of the ship body to lift up the ship body at the moment, the water in the air cabin will be negative pressure with the air cabin which no air in the cavity at the moment of storm push one side of ship body lift up ship body, the gravity of the whole set ship body plus the gravity of water om the cavity is vector value>1 then drag the ship body; for the height of typhoon and high seas over the deck cabin, the stable center of the ship body will has smaller deviate swing, combine with the performance of the gravity block and the boarding plate, it able to recover stable center rapidly; able to anti the typhoon above level 17 to attack the ship body, keep the ship body stable balance; the dual flows conversion process of the opposite time of the air discharge of the whole set air cabin b_{ψ}′ and the enter water at 5~20 minutes, strive for time to ship body anti storm; for the special requirements of the ships with special application, able to make the ships whole set sinking to a certain depth under the horizontal, the advantages are that quick dive speed, safe and reliable; act the performance of dual flows conversion force.

(6) Utilize the combine of the dual flows conversion force and impeller to improve the navigation speed of flat structure ship body; make the stern ends 0.5 m~20 m deviate to the center to install the impeller, longitudinal left and right both sides bottom stowage water cabins cabin bottom installed two sets impeller, able to additionally install 1~2 sets impellers at the gravity cabin cabin bottom according to the application of ships, longitudinal make the air cabin seal plate face to center deviate 1 m~70 m as joint point to install the impeller, the super big type ships able to install 3~5 sets impeller, among, one set able to be installed on the longitudinal axel which backward ⅙~⅕ ship length where close to the hull cabin bottom center, open one round shape cabin port at the corresponding position respectively, install column straight gear planet gear in the cabin bottom round shape cabin port, the impeller horizontal shaft form 90° with cabin bottom vertical transmit shaft, both shaft ends are the incline face gear cooperate with transmission impeller to rotating, install motor, the planet gear and the vertical axel in the round shape cabin port on the rude plate case and fixed by the sealing cover configure the same quantity motor to drive the vertical axel and the impeller horizontal shaft, the whole set the impeller rude plate case mechanism drive the planet gear and the horizontal shaft through the rude plate case and able to 360° revolving, better operating performance, the front and back impellers able to reversely rudder operate and control, form that center of circle revolving between both axel, make the whole set ship body able to gyration and displacement at any angle, make the bow shape gravity block vertical axel vertical axel mid-ship as revolve axel, picture 20-d1-e1, bow shape gravity block longitudinal front and back boundary arc external tangency line of both left and right gravity block (14) form ω ∠170°~175° with the pressurize wall, the ship body has smaller gyration radius, smaller gyration shift distance and better gyration when the ship body gyrating, the deck horizontal incline angle at 1°~3° when the ship body gyrating, both side two block gravity blocks front and back mutually parallel, small draft depth of the whole set ship body, small wet surface area, two blocks gravity blocks are slice body, thickness at 0.005 m ~0.7 m, small resistance area, small resistance value; the bow incidence θ angle formed 3°~15° small angle, combine with the dual flows conversion force, input the air into the air cabin b_{ψ}′ when navigating, lift the whole set ship body up to the min draft depth line, make whole set ship body ≥80% all are floating on the air, reduced rub resistance and stick resistance ≥80%, then combine with the impellers power and the single body structure ship body hips, if contrast with the ship body with the ball nose bow, able to improve 50%~70% navigating speed under the same power and same water displacement; the bow incidence θ angle form 3°~15° . . . ° small angle, upward lift up the ship body on y axial through buoyancy of the water when accelerate navigating, make the resistance shift to rising force, small upward restrain force on the ship body, make the navigating more quicker; better mobility of the flat structure ship body, the impeller rude plate case able to 360° revolving through drive the motor planet gear, adopt front and back impeller rude plate case reverse rude revolving to the super ships, make the ship body gyration radius smaller, smaller gyration shift distance ans short gyration time, able to reverse gyration at any angle, the front and back impeller rude plate case able to same rude displacement, form the non circling locus displacement and revolving; for the different ship transmission mechanism in different water areas, able to self select the impeller transmit mechanism, the best running scheme of cooperate with the dual flows conversion force flat structure ship body.

(7) The analyse of the gravity, gravity center, buoyancy and buoyancy center of wind load of the flat structure ship body and the single body structure ship body under the same level wind force load condition; because the wind storm will continue blow to the same one direction and blow to the ship body during the flat structure ship body navigating, f cabin combine force will caused the ship body unstable balance; picture 27-r1-s1, the unit volume of the flat structure press load water cabin, water sealing cabin and gravity cabin loaded buoyancy in the ship body cabin body is fix value under the sealing condition, not affected by the external variable thus change the size of the unit volume fix value, additionally another one is the buoyancy of the out cabin three dimensional structure space unit volume air cabin b_{Ψ}′; when the wind blow to the one face of the deck cabin up layer structures and the wind wave continue push one side of the ship body longer time, one side ship body will lift up higher then original horizontal height, the gravity deviate to another one side, oppositely reduced after the air in one side air cabin discharged from the air balance port, at the same time of the another one side of the ship body will increasing because the load transmit, the original buoyancy support force of the water sealing cabin and the buoyancy support force of the gravity cabin are the same one horizontal height, another one side air cabin also will discharge few air because the ship body incline, the ship body will sinking a certain height, but able to keep smaller gravity deviated, the internal and external cabin's two buoyancy of the air cabin b_{Ψ}′ of the water sealing cabin, gravity cabin and three dimensional structure space out of the cabin body overlap to maintain the stable balance of the ship body; when the wind force increasing to above level 8 to level 10, the wind continue blow to the one face of the deck cabin H1 up layer structures and the wind wave continue push one side of the ship body longer time, at the same time of that one side ship body will lift up higher than more bigger up and down stroke than original horizontal height, bigger gravity deviation close to the cabin bottom of the deck cabin of the another one side air cabin b′, picture 27-s1-ts, another one side will sinking bigger height; the three dimensional structure space of the flat structure cabin directly make the air as medium increased buoyancy value is one variable, affected by the external variable, the buoyancy size and position of the out cabin three dimensional structure space cabin bottom will change; when incline 3°~6°, under the performance of the cabin combine force, one side air cabin b_{Ψ}′ out cabin three dimensional structure space cabin bottom already higher the horizontal, one side ship body cabin body already no support force of the buoyancy, make one side ship body rapidly sinking bigger up and down stroke under the performance of the gravity, also the another one side the buoyancy size and position of the out cabin three dimensional structure space cabin bottom oppositely smaller change, the support force to the ship body oppositely fewer reduced, thus sinking smaller up and down stroke, will rapidly restore the horizontal height opposite to side after another one side the axle flow air compressor or air compressor circling input air to the air cabin b_{Ψ}′, the buoyancy size and position of the whole set ship body out cabin three dimensional structure space unit volume automatic circling keep stable balance; analyse and contrast the three dimensional structure space unit volume of the single body structure ship body is the fix value in the cabin body, the gravity and buoyancy all concentrate distribute on the same one plumb line depth underwater, picture 28-u1-v1, not bigger gravity deviation when ≤level 6 gale, oppositely able to keep stable balance status ans lower speed navigating, bigger deviation when the storm further more increase to above level 8 to 10, the ship will drop anchor and stop navigating under this sea status environment; the revolve axel center of the longitudinal horizontal axle of the single body structure ship body on the ship body vertical center axle, three dimensional structure space unit volume of the ship body is fix value in the cabin body; when the structure object on the up deck cabin long time blowing by the wind and caused the gravity deviated, the gravity, gravity center, buoyancy and buoyancy center of the ship body along with the revolve axel of the ship body vertical center axel as the revolve center under the f cabin combine force, same direction revolving transmission at the same time, now the gravity higher then will the ship body overturn, picture 28-v1-w1, based on the full load or empty, if empty then need fully fill water in the bottom stowage water cabins to reduce the gravity and add draft depth, add wet surface area to restrain ship body to anti storm attack, most of the ships able to anti the attack of the storm which above level 8-10, if longer time blow to the ship body one side storm, the fewest single body structure ship body will caused gravity higher and side overturn because not set the bottom stowage water cabins.

(8) The flat structure ship body compare to the single body structure ship body, is make the total mass gravity and buoyancy all concentrate distribute on the same one plumb line depth underwater to transmit to be horizontal above surface transverse front, back, left and right overlap status horizontal distributed, form the flat structure ship body, the bow opposite to the incoming flow transverse section area increasing, picture 21-h1 opposite transverse resistance bigger, except the bow incidence θ angle form 3°~15° . . . ° small angle reduce resistance technology, seeking for the max reduce resistance value to reduce the total resistance value of the ship body; opposite incoming flow resistance left and right each add one piece flow distribute plate, picture 21-f1-g1, the flow distribute plate outward deviate swing β angle 93°~95° is make the water flow of the bow opposite incoming flow center part distribute flow to both side outer part, suitably reduce the total resistance value of the ship body, at the same time, the flow distribute plate able to reduce that cut off shock of the bow both side storm wave to the bow and caused the resistance increase value, will form the resistance increase value when even speed navigating when bigger angle deviate swing of the flow distribute plate outward deviate swing β angle, too small angle deviate swing unable to act the performance of the flow distribute and reduce resistance value, select the oppositely reasonable deviate swing angle, able to rise higher navigating speed when accelerate navigating, the flow distribute plate outward deviate swing β angle 93°~95° only suitable to partial ships and some water area, include the shape structure as the design reference, modify according to the detail ships application reference value size.

(9) Because the ship body is the floating structure object between the air and water, smaller draft depth of the flat structure ship body, will generate bigger transverse rock and longitudinal rock and vibration when has wind storm, caused the unstable factors increased, generate the resistance added value at the same time, if the cargo uneven when storing then will caused the ship body side overturn, need guarantee the ship body not side overturn, solve the transverse rock and longitudinal rock to keep stability of the ship body, need reduce the gravity, lift up buoyancy center, reset the distribute gravity, gravity center, buoyancy, buoyancy center of the ship body, add pressurize wall h5 under the ship body boarding h3, horizontal boarding plate h7 on the gravity block h″, utilize the ship body attached dual slice body structure to restrain the unstable balance of the single body structure ship body to achieve the stability of the ship body, picture 22-i1-j1 through add gravity block to further more reduce gravity center, increase wet surface area, increase the restrain force of ship body; because smaller draft of flat structure, the ship body generated cache vector value when navigating also through wave type, form the counter force from the incoming flow far behind, form the pressure difference resistance when return to around the ship body and from the bow behind to the stern from the incoming flow far behind, it is transmit the cache vector value to both left and right of the ship body to fill the negative value water field behind the stern though three dimensional wave such as the wave making and the wave breaking, will generate the vortex and the turbulent flow at the same time and caused the stern horizontal transverse left and right swing, make the resistance added value; both side added two blocks gravity blocks are plane straight plate, front and back mutually parallel, regarded as the ship body attached body, the attached body increased the draft depth, also will increased the resistance, but limit added resistance; the water flow pass through both left and right side of two blocks gravity block horizontal boarding plate and horizontal boarding plate, between up and down of the cabin body of the ship body and middle flow field, except the gravity block thin slice self occupy ≤4%~7% of total resistance relative to the incoming flow water resistance and viscosity resistance, the water flow pass through both side and middle are non revolving straight line motion, not generate bigger resistance added value; when the stern generated the vortex and turbulent flow caused the horizontal transverse left and right swinging, the mass gravity of both side of the two block gravity blocks and middle water able to stop the resistance added value of left and right swinging range which generated by the vortex and turbulent flow, strengthen the navigation stability; when the storm further more increase to be above level 17, higher wave height of various different storm incline wave and wave breaking, rising of typhoon and high seas over the up deck cabin H1, picture 16 caused the ship body (1) rolling and pitch, the unstable factor of hammering further more increased; when typhoon and high seas moment push ship body one side rising, the water gravity on the water board press on the water board, the press load of gravity reduce the rising stroke, another one side support the face down of the water board, reduce the stroke of downward falling, further more increase the upward restrain force on one side of the ship body, make the opposite smaller stroke value of the ship body up and down rise and fall stroke to keep the stability of the ship body; the up and down thickness of the water board are 0.005 m~0.3 m, the thinner water board occupy 1%~2% of the total resistance, plus the gravity block thin sheet self relative to incoming flow water resistance and viscosity resistance occupy ≤4%~7% of the total resistance; longitudinal both ends of the boarding plate and the gravity block bow shape boundary form one piece arc, the arc is one piece rising force curve which able to generate the rising force, make the ship body able to keep upward rising force when navigating; the boarding plate horizontal longitudinal length direction and the horizontal cabin bottom of the deck cabin parallel to the cabin bottom of the water sealing cabin, both side two gravity blocks and the boarding plate are slice body plane straight plate, longitudinal up, down, left and right oppositely parallel, the pass through water flow is non revolve straight line motion, not generate bigger resistance added value, keep the oppositely min resistance, at the same time, able to make the opposite max restrain force to make ship body up and down rise and fall stroke size oppositely keep min value, keep stability of the ship body at the same time of quick performance of the ship body.

(10) To reduce the incoming flow resistance, make the dual flows conversion force act better performance in the flat structure ship body, set the bow incidence θ angle form 3°~15° . . . ° small angle, make it able to generate the rising force effect, during the ship body navigating generate rising force, when the bow oppositely hedging with the wave making resistance, the bow cabin bottom boarding h3 bottom line will higher than the whole set boarding h3 bottom line and form the backward incline status, this is because the ship body will make the dual flows conversion plate of the stern lift up a certain height at the same time that ship body start navigating, less than the whole set boarding h3 bottom line depth, make the air flow out from the dual flow conversion plate 18, the ship body reverse navigating; the down boundary will sinking at the moment of discharge the air, caused the bow boarding h3 upward lift up or one side of the bow lift up, the air flow out the bottom line, form the whole set cabin bottom of the air cabin not on the one piece horizontal line; the air will flow out from the bow boarding h3 bottom line, the bow sinking rapidly at the moment of flow out, thus generate front overturn and caused longitudinal rock or transverse rock; the down boundary setting air balance pocket in the whole set air cabin h₃ backward to the water cabin bottom of sealing cabin joint point which make the internal whole set air cabin of the bow downward air cabin of the outer hull as joint point, the air balance pocket is soft fibre cloth materials, from the air cabin internal down boundary of both side the water seal cabin h3 cabin bottom joint point to the bow outer hull downward air cabin downward transverse boundary as the joint point, boundary of three edges connect to be the type U air balance pocket, the width of the air balance pocket are 0.2 m~1.5 m, another one side of the air balance pocket longitudinal multiply points connect to both side air cabin transverse vertical isolate plate down port boundary and the cabin bottom of the gravity cabin, the air balance pocket produced to be oval curve shape pocket bottom, the air balance pocket able to form the oval curve or para-curve shape when withstand air pressure, make the air balance pocket pocket bottom downward exceed the boarding h₃ cabin bottom line depth, achieved that the whole set cabin bottom of the air cabin front and back horizontal depth is accordance, buffer damp bow pitch caused trim, the bow will has different period pitch when has bigger storm, the bow air balance pocket′ pocket bottom able to automatic lift up to above the bow boarding h₃ bottom line when period fallen to valley, make the stern keep on the same horizontal line, the air balance pocket and incoming resistance mutually exchange resistance reduce the resistance up and down position and size of the value during the ship body navigating, at the same time of keep ship body stable balance, act the performance that min resistance value oppositely.

(11) Able to increase 50%~100% deck area under the premise of same power and same displacement; the flat structure ship body is distribute the total mass gravity and buoyancy to distribute on the horizontal above surface transverse front, back, left and right overlap status horizontal distributed, form the flat structure ship body, this increase the horizontal area; Add the deck area according to different requirements of the different ships, add the margin of the deck cabin; example the large scale container cargo ships, not only need big water discharge, but also need big deck area, should use the flat structure ship body under the premise of that under the same power and same water discharge and able to increase deck area ≥50%, then can increase ≥50% container load cargo quantity, and not affect the navigating speed; the same, the large scale passenger liner not only need big water discharge, but also need big horizontal area and has the enough more cabin space and casino space, the opposite navigating speed able to reduce 1 to 5 knots, but the safety and reliability is first; through picture 27-r1-s1-t1, the flat structure ship body and picture 28-u1-v1-w1, contrast with the single body structure ship body, the flat structure ship body under the premise of that under the same power and same water discharge and able to increase deck area ≥50% big horizontal area and the enough more cabin space and casino space, because the flat structure ship body increase the horizontal area, opposite the single body structure ship body then can reduce the width and height ratio of the ship body, reduce the ship body height, strengthen the stability of the ship body; reduce the navigating speed under the equal condition, able to increase the total water discharge or increase the empty ship body weight; picture 16, under the bad sea status environment that meeting the bigger storm, ship body hull able to sink to horizontal positive and negative±up and down to resist the attack of the storm to keep ship body stable balance; contrast with the single body structure ship body then can improve 3~6 storm level defence capacity, the flat structure ship body to the middle and small scale ships with the special requirements, able to add 50%~100% deck area and cabins under the premise that same power and same water discharge; some ships expand the water discharge or increase navigating speed then increase power because special requirements of that need bigger horizontal area and more function setting, the actually required load needn't be bigger; the flat structure ship body at the same time of meeting the required deck area and cabins, able to increase navigating speed 50%~70% under the premise that same power and same water discharge, and keep stable balance of the ship body.

(12) Need build the modern ships for the modern war requirements, able to fighting on open sea, motive flexibly, high navigating speed, has enough big platform and space, the volume of the ships need achieved that 250000~400000 tons level, this volume means the size of ships achieved the same water discharge navigating speed length, width and height required size, aim to the technical advantages of this invention to realize that high navigating speed and motive flexibly, able to carry more advanced weapons, ammo, equipment, people, materials, energy and others, able to fight on open sea, not load the same weight objects; increase the navigating speed to above 70 knots, the deck length need to achieve that fighter plane directly take off and landing, needn't catapult take off, able to adopt that one long one short combine or one long two short combine, able to independently cruise, design to be single ship take off, the landing only need add arresting ropes, needn't catapult take off, the width achieved that four-five channels direct to the deck, take off and landing at the same time, set the dual ships islands, configure the advanced defence weapons, carry micro unmanned ships or micro submarine and satellite communication, the unmanned ships keep a certain distance with the mother ships when fighting, launch strong magnetism wave to guide enemy radar or missiles, the unmanned ships adopt long wave or middle wave to communicate with the mother ships to evade search of the enemy radar, thousand tons level middle and small scale landing boats and able to configure the electric driven wheel for landing and on shore; create one mobile military affairs base, far over the value of one fix military affairs base; the dual flow conversion force flat structure ship body able to meeting the technical requirements of the above all conditions; able to use the common power system or nuclear system; the whole set flat structure ship body and functions make the future assorted sweep power push the ship body navigating created the better base, still able to configure the leak air sac to reduce the resistance; for various different application ships, different water areas, example the sea, river and lake adopt different structure distribution, able to partially modify the opposite position and size value of the gravity, buoyancy to reduce the incoming flow resistance, reduce the cache vector value; it the world ships navigating speed maintain the existing ship's navigating speed to apply the dual flows conversion technology of the flat structure ship body, able to save ≥65% on water ships energy consumption.

### BRIEF DESCRIPTION OF THE DRAWINGS

Picture 1-a Front view diagram,

Picture 1-b Right view diagram,

Picture 2-c Front view diagram,

Picture 2-d Right view diagram,

Picture 2-e Top view diagram,

Picture 3-f Front view partial diagram,

Picture 3-g Right view diagram,

Picture 4 Top view diagram,

Picture 5-h Front view partial diagram,

Picture 5-i Right view partial diagram,

Picture 6-j Front view partial diagram,

Picture 6-k Right view diagram,

Picture 6-l Bottom view partial diagram,

Picture 7-m The single body ship body front view diagram,

Picture 7-n The single body ship body partial diagram,

Picture 8-o Front view partial diagram,

Picture 8-p Top view partial diagram,

Picture 9-q Front view partial diagram,

Picture 9-r Left view diagram,

Picture 10-s Front view diagram,

Picture 10-t Left view diagram,

Picture 10-u Top view diagram,

Picture 11-v Front view diagram,

Picture 11-w Left view diagram,

Picture 11-x Bottom view diagram,

Picture 12-y Partial section view diagram,

Picture 12-z Partial section view diagram,

Picture 13 Partial section view diagram,

Picture 14 Partial section view diagram,

Picture 15 Partial section view diagram,

Picture 16 The stern diagram,

Picture 17-a1 Partial impeller diagram,

Picture 17-b1 Partial impeller diagram,

Picture 17-c1 Partial impeller diagram,

Picture 18 Motor diagram,

Picture 19 Air compressor diagram,

Picture 20-d1 Front view partial diagram,

Picture 20-e₁ Right view diagram,

Picture 21-f1 Front view partial diagram,

Picture 21-g1 Bottom view partial diagram,

Picture 21-h1 Bottom view partial diagram,

Picture 22-i1 Front view partial diagram,

Picture 22-j₁ left view diagram,

Picture 23-k1 Front view diagram,

Picture 23-l1 Bottom view diagram,

Picture 23-m1 Left view diagram,

Picture 24 The stern diagram,

Picture 25-n1 Front view partial diagram,

Picture 25-o1 Top view diagram,

Picture 26-p1 Front view diagram,

Picture 26-q1 Top view diagram,

Picture 27-r1 The stern diagram,

Picture 27-s1 The stern diagram,

Picture 27-t1 The stern diagram,

Picture 27-u1 The stern diagram,

Picture 27-v1 The stern diagram,

Picture 27-w1 The stern diagram,

Picture 29-x1 Partial diagram,

Picture 29-y1 A-A section view diagram,

Picture 30 A-A partial section view diagram.

### DETAILED DESCRIPTION OF THE PREFERRED EMBODIMENT

The below combine with the attached diagram to process further description:

\textcircled{1} According to the picture 1-a-b, the ship body 38 bow opposite to incidence θ₁ angle≥67°, still has the ball nose bow 39 under the water, big transverse section area, big resistance, big cache vector value; picture 3-f-g, set Δ, A, B, C, θ₁ angle corresponding to ∠A·sin 67°:∠·cos 23°, ∠A>∠B, vertical axel 29 y axial >horizontal axel x axial; the bow 2 transverse left and right shipboard draft line x axial inward to be included angle, set Δ, A′, B′, C′, ∠A′ sin 47°:∠B′ cos 43°.

\textcircled{2} According to the picture 2-c-d-e the flat structure ship body 1, picture 26-p1-q1, picture 8-o-p, because the small vector value which generated by the flat structure ship body 1, picture 25-n1-o1, form the wave making 41, the sinking water body 42, the wave breaking 43, the stern wave 44, the transverse wave 45, the stern wave 44, the vortex 46 and the turbulent flow 47 and caused the resistance added value; thus the flat structure ship body 1 kinetic energy generated cache vector value need less 40%~45, the pressure difference resistance which return to around ship body 1, behind the bow 2 to the stern 5 oppositely less 40%~45%, the flat structure ship body 1 opposite the setting of the bow 2 incidence θ angle 3°~15° . . . °, picture 5-h-i, ∠b make ≥70%~80% resistance to convert to rising force through buoyancy of the water; set Δ a, b, c, incidence θ angle corresponding to ∠a·sin 8°~15: ∠b·cos 82°~75°, ∠a is 1/10~⅕ of ∠b; because the resistance of the incidence θ angle<∠a<85% of ∠b at the resistance of vertical to the horizontal axle y axial<resistance of horizontal longitudinal axel x axial; the bow 2 transverse left and right board draft line axial z inward form the included angle, set Δ, a′, b′, c′, ∠a′ sin 40°: ∠b′ cos 50°, ∠a′<∠b′; means the transverse vertical axial y<the horizontal axial z and the longitudinal vertical axial y<the horizontal axial x; combine the buoyancy of water 36 to make it convert to be rising force; also because the transverse section area is ½~⅗ of the single body ship body 1, thus also reduced ½~⅖ of the section area resistance; three component resistance vector value, the small angle θ angle 3°~15° . . . ° of the ship body 1 accelerate navigating able to generate bigger rising force, smaller generated vector value opposite to the ship 1 kinetic energy, smaller counter force released cache vector value, small unit area loaded ship body 1 gravity ∠a·sin, small wet surface area, small rub resistance, small stick resistance, small restrained force of the ship body 1 during navigating, combine withe buoyancy of the water convert the partial resistance to be rising force; bigger displacement distance within unit time opposite to the ship body 1 accelerate navigating.

\textcircled{3} Picture 6-j-k-l, according to the full load displacement quantity, means the total mass, use M represent total mass, distribute total load M on horizontal above surface transverse front, back, left and right overlap to distribute, make the length L, width W and height H of one stere/m³ as the scale and fix at the 1000 Kg/m³ and as the deck area, make the 1000 Kg/m³ as the total deck area S/m², make the gravity, buoyancy distribute coefficient table (1) as the calculation reference coefficient; make the gravity, buoyancy horizontal incline to up section, transverse front, back, left and right overlay status horizontally distributed, able to increase 50%~100% deck area under the premise of same power and same displacement;

\textcircled{4} The flat structure bow levelly look down setting as trapezoid relative to the incoming flow, picture 6-j-k-l from the bow 2 frontier both side to the outer hull 6 boundary to be included angle Δ angle 21°~25°, both side is arc boundary to be bow shape, bow shape chord height h′≥0.3 m~0.5 m; make the transverse bow 2 ship bottom to stem trapezoid frontier both edge point position as the joint point to outward deviate β angle 93°~95° and downward extend to the trapezoid bottom line as joint point and form the included angle, horizontal downward form joint point with ship bottom transverse incline bottom line and form the up and down ζ angle 30°~31°, left and right each add one piece the flow distribute plate 4, one side of the flow distribute plate 4 side vertically connect with the bow 2 down incline curve, another one side of the flow distribute plate 4 downward and backward extend to ship bottom with incidence θ angle, transverse form the joint point δ angle ∠6°~7°, make joint point δ angle extend to the bow 2 and form the joint point with ζ angle extend line and form the λ angle ∠52°~151°, form Δ δ, λ, σ flow distribute plate 4, the flow distribute plate 4 longitudinal section both left and right sides connect with ship bottom and form two pieces flow distribute plates 4, Δ δ, λ, σ flow distribute plate 4 section is cutter blade incline vertical face; the setting of the described flow distribute plate 4 based on size of water discharge quantity, the middle and small scale ships able to install one piece flow distribute plate 4 at middle of ships, or not install the flow distribute plate 4.

\textcircled{5} How the flat structure ship body 1 solve the transverse rock and longitudinal rock to keep stability of the ship body 1; need reduce the gravity, lift up buoyancy center, reset the distribute gravity, gravity center, buoyancy, buoyancy center of the ship body 1, picture 23-k1-l1-m1, downward extension from the bow 2 and the outer hull 6 to the stern 5 both side deck cabin 3, add the bottom stowage water cabins 7; picture 9-q-r, the height of the bottom stowage water cabin make H as cardinal number to multiply by 2 times height of deck cabin 3, 2·H is height of the bottom stowage water cabin h; the length of the bottom stowage water cabin 7 from the bow 2 outer to the stern 5 both end as the bottom stowage water cabin, the bottom stowage water cabin frontier bow outer hull 6 down with the stern 5 incidence θ angle extending line to the bottom stowage water cabin 7 bottom to be the same one θ angle 3°~15°; the width of the bottom stowage water cabin 7 is 8%~13% of the whole set deck cabin 3 B width is each width of both side of the bottom stowage water cabin 7b; add gravity cabin 8 (cargo cabin) at middle of both side the bottom stowage water cabins 7, each obligate 3%~5% of deck cabin 3 B width between both side of gravity cabin 8 and the bottom stowage water cabin 7 as the width of the air cabin b′, the rest width b1 as the width of the gravity cabin 8b1, make the center line of the deck cabin 3 B width as axel line to equal divide the width of the gravity cabin 8b1 toward both side; the height of the gravity cabin 8 make the deck cabin 3 H/m³ as cardinal number to multiply by 3·H times height, then subtract 2%~4.5% of 3·H times height and as the height of the gravity cabin 8h1; the length of the gravity cabin 8 make the stern 5 end inward indent 1.1%~2%/m of the length of the bottom stowage water cabins 7 the gravity cabin 8 stern 5 to the bow 2 outer hull downward transverse section and the bow 2 incidence θ angle extension surface to form the same angle curve, this is length of the gravity cabin 8l1; make the center ling of the deck cabin 3 width B as the axle line, outer downward extend 5%~8% of the gravity cabin 8 3·H times height of the gravity cabin 8 and set the center vertical isolate plate 40h2, both left and right boundary of the gravity cabin 8 set the height of 3·H times deck cabin 3 as the vertical air balance plate h2, one block vertical isolate plate l1 and two blocks vertical air balance plate l1 which length front and back equal to the cabin bottom 1 of the gravity cabin 8; make the internal side vertical surface of both side of bottom stowage water cabins 7 downward extending, picture 10-s-t-u, from the downward bottom line of the outer hull and the incidence θ angle form the same angle joint point to the stern 5, add the same height of deck cabin 3≥H 6 height, set the boarding h3 for the boarding h3 height, seal front and back surface among both side bottom stowage water cabins 7 and gravity cabin 8, front seal plate 19 and the bow 2 incidence θ angle extension line to form the same angle curve, the back seal plate 19 and the cabin bottom of the gravity cabin 8 are the same height same vertical surface seal plate 19, set the dual flows conversion plate 18 between the down of the cabin bottom of the gravity cabin 8 and same height with the boarding h3, form the non bottom air cabin h3 which bottom no solid materials sealed, the whole set bottomless air cabin is open cavity which circled by solid materials, according to the inverted open container buckle on the water, form the bottomless air cabin 9h3, utilize the liquid level as one surface of seal close loop cavity, form one close loop cavity which able to open and close; bottom of the bottomless air cabin 9 lower than horizontal with a certain depth; the bottomless air cabin 9 hereinafter simply called air cabin 9h3; air is compressed liquid, the cabin bottom of the air cabin air intensity of pressure P=P₀+ρ_{water} gh/s², the cabin bottom of the air cabin and ρ_{water} gh depth are equal, the air cabin volume represented by L/m³, the horizontal area represented by S2, P0=1 standard atmosphere, the air in the air cabin equal to: the air cabin volume is L/m³·ₐᵢᵣ gh/s²; P0+ρ_{water} gh/s²=P0+L/m³·ρₐᵢᵣ gh/s²>1 standard atmosphere, the size of the value based on the size of draft depth h; the whole set air cabin 9 width is 70%~80% of the deck cabin 3 B width as the width of the whole set air cabin 9 width bΨ, the whole set air cabin 9 make air layer completely isolate with a certain thickness, the contact space among water, deck cabin 3 and the cabin bottom of gravity cabin 8; the whole set air cabin 9 longitudinal divided into four pieces air cabins, two pieces air cabin of the cabin bottom of the gravity cabin 8 represented by bΨ; make the interval which make 10%~20% of the front and back longitudinal length from the stern 5 gravity cabin 8 vertical surface to both side air cabin b′ of the stern 5, isolate to be multiply air cabin l2, the vertical isolate plate 13h1 height level to the cabin bottom of the gravity cabin 8, down boundary of the vertical isolate plate 13 able to incline one angle behind the stern 5 based on different ship isolate plate, picture 11-v-w-x, length of l2 is length of each one air cabin; through the above distribution oppositely reduced the gravity, rising the floating center, partial floating center higher than partial gravity, and the acting force of this floating center opposite to the added buoyancy out of ship body 1 the deck cabin 3 and cabin body, the three dimensional structure space out of ship body 1 cabin body directly make air as medium to increase buoyancy support force increase floating center, the acted surface of the support force surface at the cabin bottom of the deck cabin 3, form both side two force arm through air to lift up both side bottom stowage water cabins 7 and middle gravity cabin 8.

\textcircled{6} How to utilize the flat structure ship body 1 to achieve the performance of dual flows conversion force and keep the stability of the ship body 1; need overcome the strike of different size storms, from the stern 5 both side bottom stowage water cabins 7 outer side inward each retract 1.5%~2.5% width of the deck cabin 3 B width, longitudinal make the bow 2 and the outer hull 6 to the stern 5 to form streamline type structure, reduce the rub resistance in the boundary layer, picture 10-s-t-u; make the indented joint point under the deck cabin 3 as the joint point, ½ position of downward and inward to the bottom stowage water cabins 7b bottom line width to be joint point, up and down side connected by arc curve, joint point at the bottom stowage water cabins 7b bottom line width position and set the water seal cabin 23 width, then downward extend the deck cabin 3 H times height as the water seal cabin 23h4 height and same height with the boarding h3, the water seal cabin 23 length make the center between two points which make the stern 5 ends and the bottom line of 3·H times deck cabin 3 height of bow incidence θ angle extension line as joint point to be axle line, side both ends inward indent 5%~8%/m of the bottom stowage water cabin's cabin bottom length, this is length of the water seal cabin 23l3, both ends of the water seal cabin 23 downward to the center cabin bottom from the bottom stowage water cabin's cabin bottom, connect to the bottom stowage water cabin's cabin bottom through ratio of height-length ratio 1 m:6 m as joint point curve, the described the water seal cabin 23 bottom downward, set the height of pressurize wall 48h5 at the height where the bottom stowage water cabins 7 both side internal boarding h3 bottom line downward extending increase 0.03 m~0.25 m; start from the both side pressurize wall 48 down bottom line, the horizontal length line from the stern 5 end to the bow 2 outer hull 6 and the bow 2 incidence θ angle extending line to be joint point as the length of the pressurize wall 48 l4; make the horizontal height line of the pressurize wall 48h5 as the string, the axel line which make the center of the water seal cabin 2313 length vertical downward extending 5~3·H times deck cabin 3 height as the string height h″, the string height which set as vertical bow shape gravity block h″, parallel at longitudinal left and right two blocks gravity block, the distance between both points of the string length of the gravity block make the joint point of the water seal cabin 23 both ends cabin bottom curve joints is string length of the gravity block l5, longitudinal transverse section of the gravity block is thin sheet body, thickness 0.005 mm~0.7 m is the longitudinal width of the gravity block b4, make the string of the both side of the gravity block as start point, 2.2~1.8·H times height h6 of longitudinal downward extending deck cabin 3 as the joint point to set the horizontal water board 15 string height h6, the horizontal water board 15 mutually vertical to the gravity block, longitudinal both side each wide 0.2 m~1.6 m as the width of water board 15b5, longitudinal length make the distance between front and back bow shape sting side of the gravity block as the length of the water board 16, the height h7 of the water board 15, means the up and down thickness 0.005 m~0.35 m, the size and draft of both side width of the water board 15 increase or reduce according to the structure height above the waterline, size of the load gravity distribute value and different position; the pressurize wall 48h5 vertical surface open air balance port 17 which downward extend 0.02 m~0.1 m height from boarding h3 bottom line as the joint point, make front transverse vertical isolate plate h1 line of each one air cabin 12 as joint point, backward horizontal extend 1.5%~3.5%/m of the air cabin as length of the air balance port 17, width is the width of the pressurize wall 48 b4, set the air balance port 17, the air balance port 17 is rectangle through hole, height of the air balance port 17h8 is 0.02 m~0.2 m; open two holes at top of each one air cabin b′ at both side of longitudinal and open two holes on two air cabin's cabin bottom, one is air inlet hole, one is air outlet hole, install valve at the same time, the air inlet hole 11 connect to the axle flow air compressor 27 or the air compressor; picture 13 make the stern 5 gravity cabin 8 seal plate 19 down boundary height line as joint point, set the dual flows conversion plate 18, the length equal to the width of the bottomless air cabin 9b_{ψ}′, the up and down width represented by height as h9, 2%~4% of 3·H height as height of the dual flows conversion plate 18h9, the side profile is the horizontal downward and backward arc curve, form the dual flows conversion plate 18 curve body which arc curve body is “Archimedes helical line”, make the dual flows conversion plate 18 transverse side and the stern 5 gravity cabin 8 seal plate 19 down boundary height line as joint point, use the hinge 20 at the connect position, transversely connect multiply pieces hinge 20 structure, and make the up and down revolve shaft of the hinge 20 as axial to adjust the up and down stroke of the dual flows conversion plate 18, transversely set and install 2~20 pieces hydraulic push-pull rods 24, the shock absorber 21 and the link rod 22 on the concave surface of the dual flows conversion plate 18, connect the shock absorber 21 and the shock absorber 21 link rod 22 on the concave surface of the dual flows conversion plate 18, one end of the link rod 22 connect and fix on the revolve shaft of the stern 5 gravity cabin 8 vertical seal plate 19 surface, another one end of the link rod 22 connect the hydraulic push-pull rod 24, another one end of the hydraulic push-pull rod 24 fix on the stern 5 gravity cabin 8 vertical seal plate 19 surface, the convex surface of the dual flows conversion plate 18 is the curve air sac 16.

\textcircled{7} When the flat structure ship body 1 meeting ≥level 8 gale, it will occur various different storm, incline wave, tidal wave, caused transverse rock, longitudinal rock and other unstable balance; firstly close the air inlet port and valve which on top of the air cabin b_{ψ}′, picture 15, open the air outlet hole 10 valve which on top of the air cabin, discharge a certain unit volume air, picture 14, lift up the dual flows conversion plate 18 to a certain height through the hydraulic push-pull rod 24, make the air cabin enter a certain height water, make the whole set ship body 1 reduce a certain height, ad the draft depth of the ship body 1, then close the air outlet valve, the air cabin still has partial air, now the air pressure in the cavity≈equal to the outer atmosphere; at the moment of the storm push one side of the ship body 1 lift up the ship body 1, generate the negative pressure at the moment of the water in the air cabin will make the air in the air cabin cavity under the external atmosphere reduce along with water, the water will along with the storm rising to absorb in the cavity and drag the ship body 1, now, the moment of the ship body 1 one side lift up, the ship body 1 gravity plus the water gravity is >1 storm shock vector thus drag the ship body 1; then combine with the performance of the gravity block and the boarding plate, the ship body 1 will rising and falling along with the wave peak and wave valley alter rising and falling, but the up and down range of the ship body 1 rising and falling is the up and down range of the vector which <1 storm shock, the opposite rising and falling stroke need be smaller, the ship body 1 able to continue keep low speed navigating and keep the opposite stable balance; when the storm further increase to be above level 17, various different wave height of the storm incline wave and tidal waves higher, these caused the transverse rock, longitudinal rock, vibration and other unstable factors of the ship body 1 further more increasing; the ship will drop anchor and stop navigating under this sea status environment, but for that load more light mass cargo objects and the structure object on deck cabin 3 H1 are higher, some ships will filling water in the bottom stowage water cabins 7 to reduce the ship body 1 gravity, increase the draft depth to anti storm attack, reduce risk, oppositely keep the stable balance within a certain range, but the reduced height with limit, unable to completely solve the risks; some ships not set the bottom stowage water cabins 7, the risk will be bigger, some will caused the ship body 1 overturn; opposite to the flat structure ship body 1 will firstly close the air inlet port and valve which on top of the air cabin b_{ψ}′, picture 15, open the air outlet hole 10 valve which on top of the air cabin, downward press the dual flows conversion plate 18 to the boarding h3 bottom line height through the hydraulic push-pull rod 24, fully filling water in the air cabin, then close the air venting hole valve, combine with fully filled water in the bottom stowage water cabins 7, reduce the whole set ship body 1 to the deck cabin 3 H1 positive and negative±up and down horizontal, when the storm push one side of the ship body 1 to lift up the ship body 1 at the moment, the water in the air cabin will be negative pressure with the air cabin which no air in the cavity at the moment of storm push one side of ship body 1 lift up ship body 1, the gravity of the whole set ship body 1 plus the gravity of water om the cavity is vector value>1 then drag the ship body 1; for the height of typhoon and high seas over the deck cabin 3, the stable center of the ship body 1 will has smaller deviate swing, combine with the performance of the gravity block and the boarding plate, it able to recover stable center rapidly; able to anti the typhoon above level 17 to attack the ship body 1, keep the ship body 1 stable balance.

\textcircled{8} Utilize the combine of the dual flows conversion force and impeller 25 to improve the navigation speed of flat structure ship body 1; make the stern (5) ends 0.5 m~20 m deviate to the center to install the impeller (25), longitudinal left and right both sides bottom stowage water cabins (7) cabin bottom installed two sets impeller (25), able to additionally install 1~2 sets impellers (25) at the gravity cabin (8) cabin bottom according to the application of ships, longitudinal make the air cabin seal plate (19) face to center deviate 1 m~70 m as joint point to install the impeller (25), the super big type ships able to install 3~5 sets impeller (25), among, one set able to be installed on the longitudinal axel which backward ⅙~⅕ ship length where close to the hull (6) cabin bottom center, open one round shape cabin port (30) at the corresponding position respectively, install column straight gear planet gear (30) in the cabin bottom round shape cabin port (30), the impeller (25) horizontal shaft (33) form 90° with cabin bottom vertical transmit shaft, both shaft ends are the incline face gear (34) cooperate with transmission impeller (25) to rotating, install motor (50), the planet gear (32) and the vertical axle (29) in the round shape cabin port (30) on the rude plate case (35) and fixed by the sealing cover (31), configure the same quantity motor (26) to drive the vertical axel and the impeller (25) horizontal shaft (33), the whole set the impeller (25) rude plate case (35) mechanism drive the planet gear (32) and the horizontal shaft (33) through the rude plate case (35) and able to 360° revolving better operating performance, the front and back impellers (25) able to reversely rudder operate and control, form that center of circle revolving between both axel, make the whole set ship body (1) able to gyration and displacement at any angle, make the bow shape gravity block (14) vertical axel vertical axel mid-ship (28) as revolve axel, longitudinal front and back boundary arc external tangency line of both left and right gravity block (14) form ω ∠70°~175° with the pressurize wall (48), the ship body (1) has smaller gyration radius, smaller gyration shift distance and better gyration when the ship body (1) gyrating, the deck horizontal incline angle at 1°~3° when the ship body (1) gyrating, both side two block gravity blocks (14) front and back mutually parallel, it has better navigating stability, the whole set ship body (1) draft depth is ¼~⅕ of the single body structure ship body (38), thus reduced ¾~⅘ depth underwater resistance, fewer wet surface area, two block gravity blocks (14) are slice body, thickness at 0.005 m~0.7 m, small resistance area, small resistance value; the bow (2) incidence θ angle formed 3°~15° small angle, combine with the dual flows conversion force, input the air (37) into the air cabin (9) b_{ψ}′ when navigating, lift the whole set ship body (1) up to the min draft depth line, make whole set ship body (1) ≥80% all are floating on the air (37), reduced rub resistance and stick resistance ≥80%, then combine with the impellers (25) power and the single body structure ship body (38) ships, if contrast with the ship body with the ball nose bow (39), able to improve 50%~70% navigating speed under the same power and same water displacement.

\textcircled{9} When the bow 2 oppositely hedging with the wave making 41 resistance, the bow 2 cabin bottom boarding h3 bottom line will higher than the whole set boarding h3 bottom line and form the backward incline status, this is because the ship body 1 will make the dual flows conversion plate 18 of the stern 5 lift up a certain height at the same time that ship body 1 start navigating, less than the whole set boarding h3 bottom line depth, make the air flow out from the dual flow conversion plate 18, the ship body 1 reverse navigating; the down boundary will sinking at the moment of discharge the air, caused the bow 2 boarding h3 upward lift up or one side of the bow 2 lift up, the air flow out the bottom line, form the whole set cabin bottom of the air cabin not on the one piece horizontal line; the air will flow out from the bow 2 boarding h3 bottom line, the bow 2 sinking rapidly at the moment of flow out, thus generate front overturn and caused longitudinal rock or transverse rock; the down boundary setting air balance pocket 49 in the whole set air cabin 9h₃ backward to the water cabin bottom of sealing cabin joint point which make the internal whole set air cabin of the bow 2 downward air cabin of the outer hull 6 as joint point, the air balance pocket 49 is soft fibre cloth materials, from the air cabin internal down boundary of both side the water seal cabin 23h3 cabin bottom joint point to the bow 2 outer hull 6 downward air cabin downward transverse boundary as the joint point, boundary of three edges connect to be the type U air balance pocket 49, the width of the air balance pocket 49 are 0.2 m~1.5 m, another one side of the air balance pocket 49 longitudinal multiply points connect to both side air cabin transverse vertical isolate plate down port boundary and the cabin bottom of the gravity cabin 8, the air balance pocket 49 produced to be oval curve shape pocket bottom, the air balance pocket 49 able to form the oval curve or para-curve shape when withstand air pressure, make the air balance pocket 49 pocket bottom downward exceed the boarding h₃ cabin bottom line depth, achieved that the whole set cabin bottom of the air cabin front and back horizontal depth is accordance, buffer damp bow pitch caused trim, the bow 2 will has different period pitch when has bigger storm, the bow 2 air balance pocket 49 pocket bottom able to automatic lift up to above the bow 2 boarding h₃ bottom line when period fallen to valley, make the stern 5 keep on the same horizontal line, the air balance pocket 49 and incoming resistance mutually exchange resistance reduce the resistance up and down position and size of the value during the ship body 1 navigating, at the same time of keep ship body 1 stable balance, act the performance that min resistance value oppositely.

\textcircled{10} The unit volume of the flat structure press load water cabin, water sealing cabin and gravity cabin 8 loaded buoyancy in the ship body 1 cabin body is fix value under the sealing condition, picture 27-r1-s1 not affected by the external variable thus change the size of the unit volume fix value, additionally another one is the buoyancy of the out cabin three dimensional structure space unit volume air cabin b_{Ψ}′; when the wind blow to the one face of the deck cabin 3 up layer structures and the wind wave continue push one side of the ship body 1 longer time, one side ship body 1 will lift up higher then original horizontal height, the gravity deviate to another one side, oppositely reduced after the air in one side air cabin discharged from the air balance port 17, at the same time of the another one side of the ship body 1 will increasing because the load transmit, the original buoyancy support force of the water sealing cabin and the buoyancy support force of the gravity cabin 8 are the same one horizontal height, another one side air cabin also will discharge few air because the ship body 1 incline, the ship body 1 will sinking a certain height, but able to keep smaller gravity deviated, the internal and external cabin's two buoyancy of the air cabin b_{Ψ}′ of the water sealing cabin, gravity cabin 8 and three dimensional structure space out of the cabin body overlap to maintain the stable balance of the ship body 1; when the wind force increasing to above level 8 to level 10, the wind continue blow to the one face of the deck cabin 3 H1 up layer structures and the wind wave continue push one side of the ship body 1 longer time, at the same time of that one side ship body 1 will lift up higher than more bigger up and down stroke than original horizontal height, bigger gravity deviation close to the cabin bottom of the deck cabin 3 of the another one side air cabin b′, picture 27-s1-ts, another one side will sinking bigger height; the three dimensional structure space of the flat structure cabin directly make the air as medium increased buoyancy value is one variable, affected by the external variable, the buoyancy size and position of the out cabin three dimensional structure space cabin bottom will change; when incline 3°~6°, under the performance of the cabin combine force, one side air cabin b_{Ψ}′ out cabin three dimensional structure space cabin bottom already higher the horizontal, one side ship body 1 cabin body already no support force of the buoyancy, make one side ship body 1 rapidly sinking bigger up and down stroke under the performance of the gravity, also the another one side the buoyancy size and position of the out cabin three dimensional structure space cabin bottom oppositely smaller change, the support force to the ship body 1 oppositely fewer reduced, thus sinking smaller up and down stroke, will rapidly restore the horizontal height opposite to side after another one side the axle flow air compressor or air compressor 27 circling input air to the air cabin bus′, the buoyancy size and position of the whole set ship body 1 out cabin three dimensional structure space unit volume automatic circling keep stable balance; analyse and contrast the three dimensional structure space unit volume of the single body structure ship body 38 is the fix value in the cabin body, the gravity and buoyancy all concentrate distribute on the same one plumb line depth underwater, picture 28-u1-v1, not bigger gravity deviation when ≤level 6 gale, oppositely able to keep stable balance status ans lower speed navigating, bigger deviation when the storm further more increase to above level 8 to 10, the ship will drop anchor and stop navigating under this sea status environment; the revolve axel center of the longitudinal horizontal axle of the single body structure ship body 38 on the ship body 1 vertical center axle, three dimensional structure space unit volume of the ship body 1 is fix value in the cabin body; when the structure object on the up deck cabin 3 long time blowing by the wind and caused the gravity deviated, the gravity, gravity center, buoyancy and buoyancy center of the ship body 1 along with the revolve axel of the ship body 1 vertical center axel as the revolve center under the f cabin combine force, same direction revolving transmission at the same time, now the gravity higher then will the ship body o1 verturn, picture 28-v1-w1, based on the full load or empty, if empty then need fully fill water in the bottom stowage water cabins 7 to reduce the gravity and add draft depth, add wet surface area to restrain ship body 1 to anti storm attack, most of the ships able to anti the attack of the storm which above level 8-10, if longer time blow to the ship body 1 one side storm, the fewest single body structure ship body 1 will caused gravity higher and side overturn because not set the bottom stowage water cabins 7.

The above described only the better practice cases of this invention, not limit this invention, any modification, equal return, change and improvement and others within the spirit principle of this invention, all are included in the protection range of this invention.

### REFERENCE DOCUMENTS

[1] Ship fluid mechanics, editor: Zhu Renqing, Yang Songlin, Wang Zhidong, Shanghai Jiao Tong University, second edition, 2022.8
[2] Innovation patent: Super aircraft carrier mobile platform the the structure, patent number: 201710426367.3, inventor: Hu Xiangyu
[3] Innovation patent: Three dimensional green forest three dimensional reservoir and the structure and comprehensive utilization of the wind power, PCT international name: Three dimensional green structure, patent number: ZL200810172654.7, inventor: Hu Xiangyu, patent applied day, Nov. 5, 2008
[4] Innovation patent: Independent water floating wind power transmission revolve wood tower and the transmit structure, patent number: 200710007156.2, inventor: Hu Xiangyu, patent applied day, Feb. 4, 2007

1. One new type ship, forecast of the dual flows conversion force, the gravity and the buoyancy distribution, the distribute ways and the methods of ship body (1) structure and the dual flows conversion force, the gravity and the buoyancy, the characteristics are:
The described ship body (1) still include (a), the end of ship body (1) which relative to the incoming flow is the bow (2), the another end is the stern (5);
The described ship body (1) still include (b), the deck cabin (3);
The described ship body (1) still include (c), both side of down the deck cabin (3) set the bottom stowage water cabins (7), set the gravity cabin (8) between middle of the both side bottom stowage water cabins (7);
The described ship body (1) still include (d), set the air cabin (9) among middle of the both side bottom stowage water cabins (7) and the gravity cabin (8);
The described ship body (1) still include (e), down of the bottom stowage water cabins (7) set the water sealing cabin (23); down of the water sealing cabin (23) is the pressurize wall (48), vertical surface of the pressurize wall (48) set the air balance port (17);
The described ship body (1) still include (f), down of the pressurize wall (48) set the bow shape gravity block (14);
The described ship body (1) still include (g), the end of ship body (1) which relative to the incoming flow is the bow (2), downward and backward extending to set the flow distribute plate (4);
The described ship body (1) still include (h), set the dual flows conversion plate (18) among down of the gravity cabin (8) bottom to the boarding h3 height, same height with the boarding (9) h₃;
The described ship body (1) still include (i), the down boundary setting air balance pocket (49) in the whole set air cabin (9) h₃ backward to the water sealing cabin (23) cabin bottom joint point which make the internal whole set air cabin (9) of the bow (2) downward air cabin (9) of the outer hull (6) as joint point;
The described ship body (1) still include (i), utilize the combine of the dual flows conversion force and the impeller 25 to improve the navigation speed of the flat structure ship body;
The described ship body (1) still include (k), the single body structure ship body (38), the bow angle of incidence θ₁ angle≥67°, the ball nose bow (39) kinetic energy generated cache vector value are bigger;
The described ship body (1) still include (l), the size of the cache vector value will caused the size of the stall specific value when the ship body navigating.

2. One new type ship which described according to claim 1, the described ship body (1) still include (a), the end of the ship body (1) which relative to the incoming flow is the bow (2), another end is the stern (5), the characteristics are: the flat structure bow (2) levelly look down setting as trapezoid relative to the incoming flow, from front boundary both sides of the bow (2) to the outer hull (6) boundary to form the included angle Δ angle 21°~25°, both sides are arc boundary formed to be bow shape, bow shape chord height h′ are 0.3 m~0.5 m, longitudinal from the ship bottom to the frontier boundary is curve external tangency and the bow angle of incidence θ angle to be 3°~15° straight line tangency, transverse from the bow (2) to the ship's bow front boundary to both left and right sides of the outer hull (6), downward to ship bottom to incline extending point of incidence θ angle to be joint point and come to be the oval curve left and right connection, form the curved surface.

3. One new type ship which described according to claim 1 or 2, the described ship body (1) and the bow (2) incidence θ angle come to be 3°~15° curve tangency, the characteristics are: transverse from the bow (2) to the ship's bow front boundary to both left and right sides of the outer hull (6), downward to ship bottom to incline extending point of the incidence θ angle to be joint point and come to be the oval curve left and right connection, form the curved surface; contrast the single body structure ship body (38), the flat structure ship body (1) actually under the premise of same water discharge, the transverse resistance area of the flat structure ship body (1) relative to the incoming flow less than 40%~45% of the single body structure ship body (38) deep underwater resistance area, also because the draft of the flat structure ship body (1) only ¼~⅕ of the single body structure ship body (38), thus reduced ¾~⅘ depth of the underwater resistance, the setting of the flat structure ship body (1) relative to the bow (2) incidence θ angle 3°~15°, Δ a, b, c, the incidence θ angle corresponding to ∠a·sin 8°~15°: ∠b·cos 82°~75°, ∠a is 1/10~⅕ of ∠b, because the resistance ∠a of the incidence θ angle<85% of ∠b, the bow transverse left and right board draft line axial z inward form the included angle when the resistance of axial y which vertical to horizontal axial<the resistance of horizontal longitudinal axial x, set Δ, a′, b′, c′, ∠a′ sin 40°: ∠b′ cos 50°, ∠a′<∠b′, means the transverse vertical axial y<the horizontal axial z and the longitudinal vertical axial y<the horizontal axial x, then combine the setting of the bow (2) incidence θ angle 30~15° . . . degree °, so ∠b convert ≥70%~80% of the resistance to be hoisting force through the buoyancy of the water (36); also the transverse section area is ½~⅗ of the single body structure ship body (38), thus also reduce ½~⅖ of the section area resistance; because reduce of three components resistance vector value, the small angle θ3°~15° able to generate bigger hoisting force when ship body accelerate navigating, then generate smaller vector value relative to the ship body (1) kinetic energy, smaller cache vector value which released by counter force, small ship body (1) gravity ∠a·sin value on unit area, small wet surface area, small rub resistance, small sticky pressure resistance, small upward restrained force when the ship body (1) navigating, combine with buoyancy of the water to convert partial resistance to the hoisting force; bigger displacement distance in the unit time relative to the ship body accelerate navigating.

4. One new type ship which described according to claim 1, the described ship body (1) still include (b), the deck cabin (3), the characteristics are: according to the full load draft, means the total mass, use M to represent the total mass, distribute the total load M on the horizontal incline to up section, transverse front, back, left and right overlay status horizontally distributed, make the length L, the width W and the height H of one stere/m³ as the scale and fix at the 1000 Kg/m³ and as the deck area, make the 1000 Kg/m³ as the total deck area S/m², use S represent the area, S/m² as the cardinal number; arrange the total mass M load on the horizontal incline to the up section, transverse front, back, left and right; make the percentage of 1000 Kg/m³%, the ratio between the length and width as the cardinal number of deck horizontal area S/m², the formula 1, make the percentage of M % m³=H/m³ as the deck horizontal area of L:B; the formula 2 make that total mass M divided by the deck horizontal area M/S/m²=H/m³ as the height H/m³ of the min draft depth, make this as the cardinal number of the deck cabin height; the formula 3 fix the scale of the deck width B according to that deck horizontal area S/m² divided by length L, S/m²/L-L:B, make this specific value as cardinal number, make the specification, the gravity and the buoyancy distribute coefficient table (1) as the calculation reference coefficient; make the gravity, buoyancy horizontal incline to up section, transverse front, back, left and right overlay status horizontally distributed, able to increase 50%~100% deck area under the premise of same power and same displacement;
M means the total mass M1000 Kg/m³, S means the deck area S/m²;
$$M {m}^{3} \% = S / {m}^{2} , \qquad formula 1$$
$$M / S / {m}^{2} = H / {m}^{3} , \qquad formula 2$$
$$S / {m}^{2} / L = L : B . \qquad formula 3$$

5. One new type ship which described according to claim 1 or 4, the described gravity and the buoyancy horizontal incline to up section, transverse front, back, left and right overlay status horizontally distributed, the characteristics are: concentrate and distribute the total mass gravity and the buoyancy on the depth which on the same one plumb line and convert to the horizontal incline to the up section, transverse front, back, left and right overlay status horizontally distributed, form the flat structure ship body (1) and deck cabin (3) H and make the deck cabin as the cardinal number, adjust the gravity, buoyancy position and size, reduce draft, reduce wet surface area, reduce incoming flow resistance, reduce rub resistance, reduce sticky pressure resistance to improve navigating speed, because the flat structure ship body (1) generate the smaller vector value, cache vector value on the horizontal incline to up surface, when these cache vector value through the wave making (41) type, when return to the ship body around and form the transverse wave (45) and back of the bow (2) to the stern (5) and form the pressure difference resistance from the far behind of the incoming flow far behind at counter force, transmit cache vector value to form the stern wave (44) to fill the stern behind the negative value water field toward both left and right sides of the ship body through the wave making (41), wave breaking (43) or rough-sea (43) three-dimensional energy, form the vortex (46) and the turbulent flow (47) thus caused resistance increasing, the flat structure ship body (1) kinetic energy generated cache vector value will be 40%~45% smaller, the pressure difference resistance which return to the ship body around and behind the bow (2) to the stern (5) also will be 40%~45% smaller oppositely; one part will collapse and sinking because the gravity performance of water body (36), if the sinking water body (42) oppositely overlay to be resistance with the flat ship body bow (2), but the draft depth of the flat structure ship body (1) only ¼~⅕ of the single ship body (38) ball nose bow (39), thus reduce ¾~⅘ of deep underwater overlap resistance, combine with small angel of the bow (2) incidence θ angle and the transverse section area will less 40%~45%, able to reduce 65%~70% resistance of the total resistance value oppositely, able to increase 50%~100% of the deck area under the premise of the same power and the same displacement.

6. One new type ship which described according to claim 1, the described ship body (1) still include (c), both side of down the deck cabin (3) set the bottom stowage water cabins (7), set the gravity cabin (8) between middle of the both side bottom stowage water cabins (7); the characteristics are: downward extension from the bow (2) and the outer hull (6) to the stern (5) both side deck cabin (3), set the bottom stowage water cabins (7); the height of the bottom stowage water cabins (7) make H as the cardinal number to multiply by two time height of the deck cabin (3), 2·H as the height of the bottom stowage water cabins (7) h, the length of the bottom stowage water cabins (7) from the bow (2) and the outer hull (6) to the stern (5) both side ends is the bottom stowage water cabins (7) 1, the bottom stowage water cabins (7) front end bow (2) and the outer hull (6) down side with the bow (2) incidence θ angle extending line to the bottom stowage water cabins (7) cabin bottom to be the same θ angle 3°~15°, the width of the bottom stowage water cabins (7) is 8%~13% of the whole set deck cabin (3) B width are each width of the both side bottom stowage water cabins (7)b, add the gravity cabin (8) (the stock cabin) between the both side bottom stowage water cabins (7), from the stern (5) both side bottom stowage water cabins (7) outer side inward each retract 1.5%~2.5% width of the deck cabin (3) B width, longitudinal make the bow (2) and the outer hull (6) to the stern (5) to form streamline type structure, reduce the rub resistance in the boundary layer; both side of the described gravity cabin and the bottom stowage water cabins (7) each obligate 3%~5% of the deck cabin (3) B width as the width of the air cabin (9)b′, the rest width b1 is width of the gravity cabin (8) b1.

7. One new type ship which described according to claim 1, the described that make the center line of the deck cabin (3) B width as the axle line and divided the width of the gravity cabin (8) b1 toward both side, the characteristics are: the height of the gravity cabin (8) make the deck cabin (3) H as cardinal number to multiply by 3·H times height, then subtract 2%~4.5% of 3·H times height and as the height of the gravity cabin (8) h1, the length of the gravity cabin (8) make the stern (5) end inward indent 1.1%~2%/m of the length of the bottom stowage water cabins (7), the gravity cabin (8) stern to the bow (2) outer hull downward transverse section and the bow (2) incidence θ angle extension surface to form the same angle curve, this is length of the gravity cabin (8) l1, the described that make the center line of the deck cabin (3) width B as the axle line, outer downward extend 5%~8% of the gravity cabin 3·H times height of the gravity cabin (8) and set the center vertical isolate plate (40) h2, both left and right boundary of the gravity cabin (8) set the height of 3·H times deck cabin (3) as the vertical air balance plate (9) h2, one block vertical isolate plate (40) l1 and two blocks vertical air balance plate (9) l1 which length front and back equal to the cabin bottom 1 of the gravity cabin (8) cabin bottom 1; has three pieces vertical isolate plate s under the cabin bottom of the gravity cabin (8), the gravity cabin center isolate plate (40) h2 and both left and right side vertical air balance plate (9) h3 formed four pieces air cabin (9) as the whole set air cabin b_{ψ}′; when the storm caused one side gas (37) discharge unit volume, the opposite another one side b_{ψ}′ air cabin (9) also will discharge the air (3) which less than unit volume, because the center vertical isolate plate (40) of the air cabin (9) b_{ψ}′ higher than the height of both side air balance plate (9) h3, so another one side air cabin (9) b_{ψ}′ discharge the unit volume gas<one side air cabin (9) b_{ψ}′ discharge unit volume gas (37), make another one side sinking stroke smaller, one side ship body (1) able to rapidly automatic regulate balance with another one side when return falling, oppositely keep stable and balance.

8. One new type ship which described according to claim 1, the described ship body (1) still include (d), set the air cabin (9) among middle of the both side bottom stowage water cabins (7) and the gravity cabin (8); the characteristics are: make the internal side vertical surface of both side of the bottom stowage water cabins (7) downward extending, from the downward bottom line of the outer hull (6) and the incidence θ angle form the same angle joint point to the stern (5), add the same height of deck cabin ≥H height, set the boarding h3 for the boarding h3 height, seal front and back surface among both side bottom stowage water cabins (7) and the gravity cabin (8), the front seal plate (19) and the bow (2) incidence θ angle extension line to form the same angle curve, the back seal plate (19) and the cabin bottom of the gravity cabin (8) are the same height vertical surface seal plate (19), set the dual flows conversion plate (18) between the down of the cabin bottom of the gravity cabin (8) and same height with the boarding h3, form the non bottom air cabin (9) h3 which bottom no solid materials sealed, the whole set bottomless air cabin (9) is the open cavity which circled by solid materials, according to the inverted open container buckle on the water, form the bottomless air cabin (9) h3, utilize the liquid level as one surface of seal close loop cavity, form one close loop cavity which able to open and close; bottom of the bottomless air cabin (9) lower than horizontal with a certain depth; the bottomless air cabin (9) hereinafter simply called air cabin h3; air (37) is compressed liquid, the air cabin (9) cabin bottom air (37) intensity of pressure P=P₀+ρ_{water} gh/s₂, the air cabin (9) cabin bottom and ρ_{water} gh depth are equal, the air cabin (9) volume represented by L/m³, the horizontal area represented by S2, P0=1 standard atmosphere, the air (37) in the air cabin (9) equal to: the air cabin (9) volume is L/m³ ρₐᵢᵣ gh/s²; P0+ρ_{water} gh/s²=P0+L/m³·ρₐᵢᵣ gh/s²>1 standard atmosphere, the whole set air cabin (9) make air (37) layer completely isolate with thickness 1.5%~3.5%, the contact space among water, the deck cabin (3) and the cabin bottom of the gravity cabin (8), the whole set air cabin (9) longitudinal divided into four pieces air cabins (9); two pieces air cabin (9) of the cabin bottom of the gravity cabin (8) represented by bΨ; make the interval which make 10%~20% of the front and back longitudinal length from the stern (5) gravity cabin (8) vertical surface to both side air cabin (9)b′ of the stern (5), isolate to be multiply air cabin (9) l2, the vertical isolate plate (13) h1 height level to the cabin bottom of the gravity cabin (8), down boundary of the vertical isolate plate (13) able to incline one angle behind the stern (5) based on different ship isolate plate (13), length of l2 is length of each one air cabin (9); open two holes at the top of each one air cabin b′ at both side of longitudinal and open two holes on two cabin bottom of the air cabins (9), one is air inlet hole (11), one is air outlet hole (10), install valve (12) at the same time, the air inlet hole connect to the axle flow air compressor (27) or the air compressor (27).

9. One new type ship which described according to claim 1 or 8, the described whole set air cabins (9), the characteristics are: through the gravity, the buoyancy horizontal above surface transverse front, back, left and right overlap status horizontal distributed, oppositely reduced the gravity, rising the floating center, partial floating center higher than partial gravity, and the acting force of this floating center opposite to the added buoyancy out of ship body (1), the deck cabin (3) and the cabin body, the three dimensional structure space out of ship body (1) cabin body directly make air (37) as medium to increase buoyancy support force increase floating center, the acted surface of the support force surface at the cabin bottom of the deck cabin (3), form both side two force arm through air (37) to lift up both side bottom stowage water cabins (7) and middle gravity cabin (8).

10. One new type ship which described according to claim 1, the described ship body (1) still include (e), set the water seal cabin (23) under the bottom stowage water cabins (7) cabin bottom, the characteristics are: make the indented joint point under the deck cabin (3) as the joint point, ½ position of downward and inward to the bottom stowage water cabins (7) b bottom line width to be joint point, up and down side connected by arc curve, joint point at the bottom stowage water cabins (7) b bottom line width position and set the water seal cabin (23) width, then downward extend the deck cabin (3) H times height as the water seal cabin (23)h4 height and same height with the boarding h3, the water seal cabin (23) length make the center between two points which make the stern (5) ends and the bottom line of 3·H times deck cabin (3) height of bow (2) incidence θ angle extension line as joint point to be axle line, side both ends inward indent 5%~8%/m of the bottom stowage water cabins (7) cabin bottom length, this is length of the water seal cabin (23)l3, both ends of the water seal cabin (23) downward to the center from the bottom stowage water cabins (7) cabin bottom, connect to the bottom stowage water cabins (7) cabin bottom through ratio of the height-length ratio 1 m:6 m as joint point curve, the described the water seal cabin (23) bottom downward, set the pressurize wall (48)h5 at the height where the bottom stowage water cabins (7) both side internal boarding (9) h3 bottom line downward extending increase 0.03 m~0.25 m.

11. One new type ship which described according to claim 1 or 10, down of the described water sealing cabin (23) set the pressurize wall (48), vertical surface of the pressurize wall (48) set the air balance port (17), down of the pressurize wall (48) set the bow shape gravity block (14), the characteristics are: set the pressurize wall (48)h5 at the height where the bottom stowage water cabins (7) both side internal boarding (9) h3 bottom line downward extending increase 0.03 m~0.25 m, the described the pressurize wall (48) vertical surface open air balance port (17), the pressurize wall (48)h5 vertical surface open air balance port (17) which downward extend 0.02 m~0.1 m height from boarding (9) h3 bottom line as the joint point, make front transverse vertical isolate plate (13) h1 line of each one air cabin (9)l2 as joint point, backward horizontal extend 1.5%~3.5%/m of the air cabin (9) as length of the air balance port (17)l7, width is the width of the pressurize wall (48)b4, set the air balance port (17), the air balance port (17) is rectangle through hole, height of the air balance port (17)h8 is 0.02 m~0.2 m, set bow shape gravity block (14) under the pressurize wall (48), suppose the ship body (1) side moment rising height because storm shocked, the opposite another one side also will change the original height because this and sink a certain height, but smaller opposite sink stroke, it is not revolve along with the vertical axle ling of the ship body (1), it's revolve center deviate to another one side gravity, the gravity of buoyancy revolve along with the revolve center, make the ship body (1) keep stable balance; even though no the circling air (37) input the whole set air cabin (9)bΨ, one side moment rising height too high when storm shocking, when too big discharge air (37) unit volume increasing through the air balance port (17), one side will return fallen sinking lower than another one side horizontal height, but another one side will generate incline because too big sinking of one side then will discharge the gas (37) which less than opposite one side unit volume, thus recover the balance of the whole set ship body; if under the situation that high wind continue push the ship body (1), the whole process is automatic multiply times circling recover balance process, the up and down stroke of the ship body (1) circling based on size of storm, but relative to the recover process of single body structure ship body (38) more smaller up and down stroke within unit time, but quicker recover balance, this is because volume of the another one side discharge gas (37) during every one time circling process relative less than volume of one side discharge gas (37); [One side and another one side is the state of mutually exchange position]; the above process is automatically finish steady state under the natural environment with storm shock; act the dual flows conversion force performance.

12. One new type ship which described according to claim 1, the described ship body (1) still include (f), down of the pressurize wall (48) set the bow shape gravity block (14), the characteristics are: add attached the block structure gravity block (14) under the whole set air cabin (9)bΨ water seal cabin (23) cabin bottom, make the horizontal height line of the pressurize wall (48) h5 as the string, the axel line which make the center of the water seal cabin (23) l3 length vertical downward extending 5~3·H times of the deck cabin (3) height as the string height h″, the string height which set as vertical bow shape gravity block (14)h″, parallel at longitudinal left and right two blocks gravity block (14), the distance between both points of the string length of the gravity block (14) make the joint point of the water seal cabin (23) both ends cabin bottom curve joints is string length of the gravity block (14) 15, longitudinal transverse section of the gravity block (14) is thin sheet body, thickness 0.005 mm~0.7 m is the longitudinal width of the gravity block (14)b4, make the string of the both side of the gravity block (14) as start point, 2.2~1.8·H times height h6 of the longitudinal downward extending deck cabin (3) as the joint point to set the horizontal water board (15) string height h6, the horizontal water board (15) mutually vertical to the gravity block, longitudinal both side each wide 0.2 m~1.6 m as the width of water board (15)b5, longitudinal length make the distance between the front and back bow shape sting side of the gravity block (14) as the length of the water board (15) l6, the height h7 of the water board (15), means the up and down thickness 0.005 m~0.35 m, the size and draft of both side width of the water board (15) increase or reduce according to the structure height above the waterline, size of the load gravity distribute value and different position.

13. One new type ship which described according to claim 1 or 12, the described ship body (1) add the attached block structure gravity block (14), the characteristics are: comprehensive improve the navigating speed and stability of ship body of the ship body (1) through the gravity of the gravity block (14), the gravity of water (36), negative pressure restrain of air cabin (9), buoyancy of water and atmosphere, has the flexible gravity block (14) and fix gravity block (14) and water board (15); now make the fix gravity block (14) and the water board (15) as sample, smaller draft of flat structure ship body (1), the ship body easily generate rolling and pitch when has bigger storm and bring unstable balance, add attached block structure gravity block (14) under the whole set air cabin (9)bΨ water seal cabin (23) cabin bottom, add horizontal water board (15) at middle and up part of the gravity block (14), further reduce gravity through add the gravity block (14), increase wet surface area, increase gravity to restrain the rolling of the reduce ship body (1), pitch bring unstable balance, both side added two blocks gravity block (14) are flat straight plate, front and back mutually parallel, regarded as ship body (1) attachment, the attachment increased the drat depth, when the water flow pass through both left and right side of two blocks gravity block (14) and middle flow field, except the gravity block (14) thin slice self occupy 3%~5% of total resistance relative to the incoming flow water (36) resistance and viscosity resistance, the up and down thickness of the water board (15) are 0.005 m~0.3 m, the thinner water board (15) occupy 1%~2% of the total resistance, plus the gravity block (14) thin sheet self relative to incoming flow water resistance and viscosity resistance occupy 4%~7% of the total resistance; the water flow pass through both side and middle are non revolving straight line motion, not generate bigger resistance added value; when the stern (5) generated the vortex (46) and the turbulent flow (47) caused the horizontal transverse left and right swinging, the mass gravity of both side of the two block gravity blocks (14) and middle water (36) able to stop the resistance added value of left and right swinging range which generated by the vortex (46) and turbulent flow (47), strengthen the navigation stability; when the storm further more increase to be above level 17, higher wave height of the various different storm incline wave and wave breaking (43), rising of typhoon and high seas over the up deck cabin H1, caused the ship body (1) rolling and pitch, the unstable factor of hammering further more increased; the ship will drop anchor and stop navigating under this sea status environment; the flat structure ship body (1) will firstly close the air inlet port (11) and valve (12) which on top of the air cabin (9) b_{ψ}′, open the air outlet hole (10) valve which on top of the air cabin (9), downward press the dual flows conversion plate (18) to the boarding h3 bottom line height through the hydraulic push-pull rod (24), fully filling water (36) in the air cabin (9), then close the air venting hole valve (12), combine with fully filled water (36) in the bottom stowage water cabins (7), reduce the whole set ship body to the deck cabin (3) H1 positive and negative ±up and down horizontal, when the storm push one side of the ship body (1) to lift up the ship body (1) at the moment, the water (36) in the air cabin (9) will be negative pressure with the air cabin (9) which no air (37) in the cavity at the moment of storm push one side of ship body (l) lift up ship body (1), the gravity of the whole set ship body (1) plus the gravity of water (36) om the cavity is vector value>1 then drag the ship body (1); when typhoon and high seas moment push ship body (1) one side rising, the water (36) gravity on the water board (15) press on the water board (15), the press load of gravity reduce the rising stroke, another one side support the face down of the water board (15), reduce the stroke of downward falling, further more increase the upward restrain force on one side of the ship body (1), make the opposite smaller stroke value of the ship body up and down rise and fall stroke to keep the stability of the ship body (1); keep stability of the ship body (1) at the same time of oppositely reduce water resistance.

14. One new type ship which described according to claim 1, the described ship body (1) still include (g), the end of ship body (1) which relative to the incoming flow is the bow (2), downward and backward extending to set the flow distribute plate (4); the characteristics are: the flat structure bow (2) levelly look down setting as trapezoid relative to the incoming flow, from front boundary both sides of the bow (2) to the outer hull (6) boundary to form the included angle Δ angle 21°~25°, both sides are arc boundary formed to be bow shape, bow shape chord height h′≥0.3 m~0.5 m, longitudinal from the ship bottom to the frontier boundary is curve external tangency and the bow angle of the incidence θ angle to be 3°~15° straight line tangency, transverse from the bow (2) to the ship's bow front boundary to both left and right sides of the outer hull (6), downward to ship bottom to incline extending point of incidence θ angle to be joint point and come to be the oval curve left and right connection, form the curved surface, make the transverse bow (2) ship bottom to stem trapezoid frontier both edge point position as the joint point to the outward deviate β angle 93°~95° and downward extend to the trapezoid bottom line as joint point and form the included angle, horizontal downward form joint point with ship bottom transverse incline bottom line and form the up and down ζ angle 30°~33°, left and right each add one piece the flow distribute plate (4), one side of the flow distribute plate (4) side vertically connect with the bow (2) down incline curve, another one side of the flow distribute plate (4) downward and backward extend to ship bottom with incidence θ angle, transverse form the joint point δ angle ∠6°~7°, make joint point δ angle extend to the bow (2) and form the joint point with ζ angle extend line and form the λ angle ∠152°~151°, form Δ δ, λ, σ flow distribute plate (4), the flow distribute plate (4) longitudinal section both left and right sides connect with ship bottom and form two pieces flow distribute plates (4), Δ δ, λ, σ flow distribute plate (4) section is cutter blade incline vertical face, the flow distribute plate (4) incline vertical face section downward and backward deviate distance ≥¼ from the ship stern as joint point, arc out of both faces incline tangency with incidence θ angle till ship bottom, form curve connection.

15. One new type ship which described according to claim 1 or 14, the described the bow (2) opposite to the incoming flow transverse section area increasing, bigger opposite transverse resistance, except the bow (2) incidence θ angle form small angle reduce resistance technology, seeking for the max reduce resistance value to reduce the total resistance value of the ship body (1), the characteristics are: opposite to incoming flow resistance both left and right side each add one piece flow distribute plate (4), the described flow distribute plate (4) outward deviate swing β angle 93°~95° is make the water flow of the bow (2) opposite incoming flow center part distribute flow to both side outer part, suitably reduce the total resistance value of the ship body (1), at the same time, the flow distribute plate (4) able to reduce that cut off shock of the bow (2) both side storm wave to the bow (2) and caused the resistance increase value, will form the resistance increase value when even speed navigating when bigger angle deviate swing of the flow distribute plate (4) outward deviate swing β angle, too small angle deviate swing unable to act the performance of the flow distribute and reduce resistance value, select the oppositely reasonable deviate swing angle, able to rise higher navigating speed when accelerate navigating, the flow distribute plate (4) outward deviate swing β angle 93°~95° only suitable to partial ships and some water area, include the shape structure as the design reference, modify according to the detail ships application reference value size; the flat structure ship body (1) opposite to the single body structure ship body (38) is change the resistance value of these three vector values through distribution of the flat structure shape; is convert the incoming flow resistance to be upward rising force through small angle conversion, this rising force only means the flat structure ship body opposite to the single body structure ship body, reduce ≥80% restrain force of water (36) to ship body on the ship body navigating direction thus generate the rising force; thus reduce the resistance, the flow distribute plate (4) outward deviate swing β angle 93°~95°, longitudinal section both left and right sides connect with ship bottom to be two pieces flow distribute plates, Δ δ, λ, σ flow distribute plate section is cutter blade incline vertical face, distribute the partial resistance of the bow (2) frontier middle incoming flow toward both side, reduce the partial resistance of incoming flow to improve navigating speed; the setting of the described flow distribute plate (4) based on size of water discharge quantity, the middle and small scale ships able to install one piece flow distribute plate (4) at middle of ships, or not install the flow distribute plate (4).

16. One new type ship which described according to claim 1, the described ship body (1) still include (h), set the dual flows conversion plate (18) among down of the gravity cabin (8) bottom to the boarding h₃ height, same height with the boarding (9) h₃, the characteristics are: make the stern (5) gravity cabin (8) seal plate (19) down boundary height line as joint point, set the dual flows conversion plate (18), the length equal to the width of the bottomless air cabin (9) b_{ψ}′, the up and down width represented by height as h9, 2%~4% of 3·H height as height of the dual flows conversion plate (18) h9, the side profile is the horizontal downward and backward arc curve, form the dual flows conversion plate (18) curve body which arc curve body is “Archimedes helical line”, make the dual flows conversion plate (18)l8 transverse side and the stern (5) gravity cabin (8) seal plate (19) down boundary height line as joint point, use the hinge (20) at the connect position, transversely connect multiply pieces hinge (20) structure, and make the up and down revolve shaft of the hinge (20) as axial to adjust the up and down stroke of the dual flows conversion plate (18)l8, transversely set and install 2~20 pieces hydraulic push-pull rods (24), the shock absorber (21) and the link rod (22) on the concave surface of the dual flows conversion plate (18), connect the shock absorber (21) and the shock absorber link rod (22) on the concave surface of the dual flows conversion plate (18), one end of the link rod (22) connect and fix on the revolve shaft of the stern (5) gravity cabin (8) vertical seal plate (19) surface, another one end of the link rod (22) connect the hydraulic push-pull rod (24), another one end of the hydraulic push-pull rod (24) fix on the stern (5) gravity cabin (8) vertical seal plate (19) surface, the convex surface of the dual flows conversion plate (18) is the curve air sac (16).

17. One new type ship which described according to claim 1 or 16, the described dual flows conversion force, means both type different fluids mutually convert to generate the acting force, the characteristics are: when the described ship body (1) start navigating, make the stern (5) dual flows conversion plate (18) upward hoist 0.5%~1.5% height through the shock absorber (21), the link rod (22) and the hydraulic push-pull rod (24), open the valve (12) through the air inlet hole (11) on top of each one air cabin (9) and make the axle flow air compressor (27) or air compressor (27) circling input air (37) into the air cabin (9), the air (37) pressure in the air cabin (9) is >1 atmosphere out of the cabin body, the air (37) pressure increasing; when the input input air (37) in the air cabin (9) achieved and exceed 95%~99.5 unit volume, the gas (37) will be discharged from the one port from more close distance outlet, make ship body (1) able to displace toward one direction; behind lift up the dual flows conversion plate (18) during the ship body (1) start navigating, make the moment air cabin (9) internal pressure reduced behind the gas (37) discharged, the stern (5) and dual flows conversion plate (18) moment falling and caused the stern overturn, when the air (37) repeat circling input the air cabin (9), it will generates high frequency shimmy, the ship body (1) stern overturn caused the pitch and make the ship body (1) loss stable, make the resistance increased value; generate damp buffer through the dual flows conversion plate (18) convex curve body air sac (16) and the shock absorber (21) on concave surface, able to reduce the high frequency shimmy, stern overturn, the described dual flows conversion plate (18) able to control and affect the navigating speed of the ship body (1), the counter acting force which discharged through the dual flows conversion air cabin opposite to the water (36), the density of the water (36) more 800 times bigger than then density of the air (37), the ship body (1) will displace at opposite direction of discharge the gas (37), the counter action force of the air (37) flow opposite to the water (36) to push the ships reversely move, the generated displacement is under the action of the dual flows conversion; if the discharge gas (37) is opposite to the air (37), also able to reversely displaced, merely the counter acting force will less ≤800 times; the flat structure ship body (1) ≥80% are floating on the air cabin (9) gas (37), stick resistance, combine with the bow (2) incidence θ angle form 3°~15° small angle, then further more input the air (37) which over the unit volume when enter into air cabin, the displacement distance and speed within unit time will further more increased, in theory, under the premise that not use impeller (25), when continue make infinite increasing power input unit volume air into air cabin (9), the speed will be infinite big under the situation that not considering other resistance factors.

18. One new type ship which described according to claim 1, the described ship body (1) still include (i), the down boundary setting air balance pocket (49) in the whole set air cabin (9) h₃ backward to the water sealing cabin (23) cabin bottom joint point which make the internal whole set air cabin (9) of the bow (2) downward air cabin (9) of the outer hull (6) as joint point, the characteristics are: the down boundary setting air balance pocket (49) in the whole set air cabin (9) h₃ backward to the water sealing cabin (23) cabin bottom joint point which make the internal whole set air cabin (9) of the bow (2) downward air cabin (9) of the outer hull (6) as joint point, the air balance pocket (49) is soft fibre cloth materials, from the air cabin (9) internal down boundary of both side the water seal cabin (23) h3 cabin bottom joint point to the bow (2) outer hull (6) downward air cabin (9) downward transverse boundary as the joint point, boundary of three edges connect to be the type U air balance pocket (49), the width of the air balance pocket (49) are 0.2 m~1.5 m, another one side of the air balance pocket (49) longitudinal multiply points connect to both side air cabin (9) transverse vertical isolate plate (13) down port boundary and the gravity cabin (8) cabin bottom, the air balance pocket (49) produced to be oval curve shape pocket bottom, the air balance pocket (49) able to form the oval curve or para-curve shape when withstand air (37) pressure, make the air balance pocket (49) pocket bottom downward exceed the boarding h₃ cabin bottom line depth, achieved that the whole set air cabin (9) cabin bottom front and back horizontal depth is accordance, buffer damp bow pitch caused trim, the bow (2) will has different period pitch when has bigger storm, the bow (2) air balance pocket (49) pocket bottom able to automatic lift up to above the bow (2) boarding (9) h₃ bottom line when period fallen to valley, make the stern (5) keep on the same horizontal line, the air balance pocket (49) and incoming resistance mutually exchange resistance reduce the resistance up and down position and size of the value during the ship body navigating, at the same time of keep ship body (1) stable balance, act the performance that min resistance value oppositely.

19. One new type ship which described according to claim 1 or 18, achieved that the whole set air cabin (9) cabin bottom front and back horizontal depth uniformity, buffer damp bow pitch caused trim, the characteristics are: the bow (2) will has different period pitch when has bigger storm, the bow (2) pocket bottom of the air balance pocket (49) able to automatic lift up to above the bow (2) boarding (9) h₃ bottom line when when period fallen to valley, make the stern (5) keep on the same horizontal line, the air balance pocket (49) and incoming resistance mutually exchange resistance reduce the resistance up and down position and size of the value during the ship body navigating, at the same time of keep ship body (1) stable balance, act the performance that min resistance value oppositely, during the buffer damp of ship body (1) navigating is automatic circling stable balance, act the performance of dual flow conversion force.

20. One new type ship which described according to claim 1, the described ship body (1) still include (j), utilize the combine of the dual flows conversion force and impeller to improve the navigation speed of flat structure ship body, the characteristics are: make the stern (5) ends 0.5 m~20 m deviate to the center to install the impeller (25), longitudinal left and right both sides bottom stowage water cabins (7) cabin bottom installed two sets impeller (25), able to additionally install 1~2 sets impellers (25) at the gravity cabin (8) cabin bottom according to the application of ships, longitudinal make the air cabin seal plate (19) face to center deviate 1 m~70 m as joint point to install the impeller (25), the super big type ships able to install 3~5 sets impeller (25), among, one set able to be installed on the longitudinal axel which backward ⅙~⅕ ship length where close to the hull (6) cabin bottom center, open one round shape cabin port (30) at the corresponding position respectively, install column straight gear planet gear (30) in the cabin bottom round shape cabin port (30), the impeller (25) horizontal shaft (33) form 90° with cabin bottom vertical transmit shaft, both shaft ends are the incline face gear (34) cooperate with transmission impeller (25) to rotating, install motor (50), the planet gear (32) and the vertical axel (29) in the round shape cabin port (30) on the rude plate case (35) and fixed by the sealing cover (31), configure the same quantity motor (26) to drive the vertical axel and the impeller (25) horizontal shaft (33), the whole set the impeller (25) rude plate case (35) mechanism drive the planet gear (32) and the horizontal shaft (33) through the rude plate case (35) and able to 360° revolving.

21. One new type ship which described according to claim 1 or 20, the described rude plate case (35) mechanism able to 360° revolving, the characteristics are: the rude plate case (35) mechanism able to 360° revolving, better operating performance, the front and back impellers (25) able to reversely rudder operate and control, form that center of circle revolving between both axel, make the whole set ship body (1) able to gyration and displacement at any angle, make the bow shape gravity block (14) vertical axel vertical axel mid-ship (28) as revolve axel, longitudinal front and back boundary arc external tangency line of both left and right gravity block (14) form ω ∠170°~175° with the pressurize wall (48), the ship body (1) has smaller gyration radius, smaller gyration shift distance and better gyration when the ship body (1) gyrating, the deck horizontal incline angle at 1°~3° when the ship body (1) gyrating, both side two block gravity blocks (14) front and back mutually parallel, it has better navigating stability, the whole set ship body (1) draft depth is ¼~⅕ of the single body structure ship body (38), thus reduced ¾~⅘ depth underwater resistance, fewer wet surface area, two block gravity blocks (14) are slice body, thickness at 0.005 m~0.7 m, small resistance area, small resistance value; the bow (2) incidence θ angle formed 3°~15° small angle, combine with the dual flows conversion force, input the air (37) into the air cabin (9) b_{ψ}′ when navigating, lift the whole set ship body (1) up to the min draft depth line, make whole set ship body (1) ≥80% all are floating on the air (37), reduced rub resistance and stick resistance ≥80%, then combine with the impellers (25) power and the single body structure ship body (38) ships, if contrast with the ship body with the ball nose bow (39), able to improve 50%~70% navigating speed under the same power and same water displacement.

22. One new type ship which described according to claim 1, the described ship body (1) still include (k), the single body structure ship body (38), the bow angle of incidence θ₁ angle≥67°, the ball nose bow (39) kinetic energy generated cache vector value are bigger, the characteristics are: the size of cache vector value will caused the size of stall specific value when ship body navigating; the cache vector value mean that, the energy value which gradually accumulate and cache in the water behind the energy spreading through water when ship body navigating; the bow (2) incidence θ₁ angle ≥67° and oppositely overlap with the ball nose bow side type S curve and form the circling resistance, part of it directly formed the resistance which make the bow type V tip head as circle center, the water (36) transmit and spreading around under the inertia performance through wave type, part of water collapse and sinking under the performance of the gravity behind spreading, for the sinking water body (42), part of it form cache vector value at far behind the incoming flow through the wave making (41) type because the inertia performance through wave type; because the cache vector value at far behind the incoming flow of the bow type V tip head, transmit to both left and right side of ship body through three dimensional type such as the wave making (41) or the sinking water body (42) or the wave breaking (43) to fill the stern behind negative water field formed the stern wave (44), the transverse wave (45), the vortex (46) and the turbulent flow (47) caused resistance added value; bigger ship body draft depth and bigger incidence θ1 angle ≥67°, more bigger consumed energy, need add power above ≥3 times per improve one knot navigating speed, bigger consumed energy if under the accelerate speed navigating situation; because the bigger ship body (38) draft depth and the bigger incidence θ1 angle ≥67°, navigating stability at middle, if no the ball nose bow (39) balance the front and back pressure difference resistance, it will has bigger trim and caused unstable balance; because the bigger ship body (38) draft depth and the bigger incidence θ1 angle >67°, bigger gyration shift distance, the draft depth very difficult to improve the speed and motility of the ship body (38), too low gravity and big resistance, higher gravity easily side overturn; the size of cache vector value will caused the size of the stall specific value when ship body navigating, the flat structure ship body (1) kinetic energy generated cache vector value need less 40%~45%, the pressure difference resistance which return to around ship body, behind the bow (2) to the stern (5) oppositely less 40%~45%; the draft depth of the flat structure ship body (1) only ¼~⅕ of the single body structure ship body (38), thus reduce ¾~⅘ depth underwater overlap resistance again; the smaller angle and transverse section area which combine with the bow (2) incidence θ1 angle will less 40%~45%, oppositely able to reduce 65%~70% of the total resistance value; the single body structure ship body (38) opposite to the incoming flow incidence θ1 angle ≥67° will be ≥8 times bigger than the flat structure ship body (1) incidence θ1 angle 3°~15°, the stall specific value will be 65%~70% bigger; not include the above wet surface area structure bring wind load specific value.

23. One new type ship which described according to claim 1 or 22, the draft depth of the flat structure ship body (1) only ¼~⅕ of the single body structure ship body (38), thus reduce ¾~⅘ depth underwater overlap resistance again, the characteristics are: the flat structure ship body (1) kinetic energy generated cache vector value need less 40%~45%, the pressure difference resistance which return to around ship body, behind the bow (2) to the stern (5) oppositely less 40%~45%; the draft depth of the flat structure ship body (1) only ¼~⅕ of the single body structure ship body (38), thus reduce ¾~⅘ depth underwater overlap resistance again; the smaller angle and transverse section area which combine with the bow (2) incidence θ1 angle will less 40%~45%, oppositely able to reduce 65%~70% of the total resistance value; the single body structure ship body (38) opposite to the incoming flow incidence θ1 angle ≥67° will be ≥8 times bigger than the flat structure ship body (1) incidence θ1 angle 3°~15°, the stall specific value will be 65%~70% bigger; not include the above wet surface area structure bring wind load specific value.
